(19) United States
(12) Patent Application Publication
(10) Pub. No.: US 2025/0055636 A1
(43) Pub. Date: Feb. 13, 2025

(54) METHOD AND APPARATUS FOR POSITIONING IN WIRELESS COMMUNICATION SYSTEM

(71) Applicant: Samsung Electronics Co., Ltd., Gyeonggi-do (KR)

(72) Inventors: Sungjin PARK, Gyeonggi-do (KR); Cheolkyu SHIN, Gyeonggi-do (KR); Kyoungmin PARK, Gyeonggi-do (KR)

(21) Appl. No.: 18/796,979

(22) Filed: Aug. 7, 2024

(30) Foreign Application Priority Data
Aug. 10, 2023 (KR) 10-2023-0105157

(51) Int. Cl. H04L 5/00; H04W 72/0446; H04W 72/25

(52) U.S. Cl. CPC H04L 5/0051; H04W 72/0446; H04W 72/25

(57) ABSTRACT

The disclosure relates to a 5G or 6G communication system for supporting a higher data transmission rate. A method performed by a first UE in a wireless communication system is provided. The method includes receiving, from a second UE, first SCI on a PSCCH, the first SCI including an SCI format field for a second SCI, in case that the SCI format field includes a first value corresponding to an SCI format for an SL PRS for a shared SL PRS resource pool, receiving, from the second UE, the second SCI corresponding to the SCI format on a PSSCH, and receiving, from the second UE, the SL PRS on the PSSCH based on the second SCI.

### CROSS-REFERENCE TO RELATED APPLICATION(S)

This application is based on and claims priority under 35 U.S.C. § 119 to Korean Patent Application No. 10-2023-0105157, which was filed in the Korean Intellectual Property Office on Aug. 10, 2023, the entire disclosure of which is incorporated herein by reference.

### BACKGROUND

### 1. Field

The disclosure relates generally to a wireless communication system and, more particularly, to a method and an apparatus for performing positioning (e.g., location measurement).

### 2, Description of Related Art

5^{th} generation (5G) mobile communication technologies define broad frequency bands such that high transmission rates and new services are possible, and can be implemented in “sub 6 gigahertz (GHz)” bands, such as 3.5 GHZ, and in “above 6 GHz” bands, which may be referred to as mmWave, including 28 GHz and 39 GHz.

In addition, 6^{th} generation (6G) mobile communication technologies (e.g., referred to as beyond 5G systems) are expected to operate in terahertz (THz) bands (e.g., 95 GHz to 3 THz bands) in order to accomplish transmission rates fifty times faster than 5G mobile communication technologies and ultra-low latencies one-tenth of 5G mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input, multiple-output (MIMO) for mitigating radio-wave path loss and increasing radio-wave transmission distances in mmWave, supporting numerologies (e.g., operating multiple subcarrier spacings) for efficiently utilizing mm Wave resources and dynamic operation of slot formats, initial access technologies for supporting multi-beam transmission and broadbands, definition and operation of a bandwidth part (BWP), new channel coding methods such as a low density parity check (LDPC) code for relatively large amount of data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by newer 5G mobile communication technologies, e.g., physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, a non-terrestrial network (NTN), which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There is ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponentially increase, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

An aspect of the disclosure is to provide an apparatus and a method for effectively providing a service in a mobile communication system.

Another aspect of the disclosure is to provide a method and a procedure in which a UE effectively performs positioning (e.g., location measurement).

The technical subjects pursued in the disclosure may not be limited to the above-mentioned technical subjects, and other technical subjects which are not mentioned may be clearly understood from the following descriptions by those skilled in the art to which the disclosure pertains.

In accordance with an aspect of the disclosure, a method performed by a first UE in a wireless communication system is provided. The method includes receiving, from a second UE, first sidelink (SL) control information (SCI) on a physical SL control channel (PSCCH), the first SCI including an SCI format field for a second SCI, in case that the SCI format field includes a first value corresponding to an SCI format for a sidelink (SL) positioning reference signal (PRS) for a shared SL PRS resource pool, receiving, from the second UE, the second SCI corresponding to the SCI format on a physical SL shared channel (PSSCH) and receiving, from the second UE, the SL PRS on the PSSCH based on the second SCI.

In accordance with another aspect of the disclosure, a first UE for use in a wireless communication system is provided. The first UE includes a transceiver and a controller coupled with the transceiver and configured to receive, from a second UE, first SCI on a PSCCH, the first SCI including an SCI format field for a second SCI, in case that the SCI format field includes a first value corresponding to an SCI format for a sidelink (SL) positioning reference signal (PRS) for a shared SL PRS resource pool, receive, from the second UE, the second SCI corresponding to the SCI format on a PSSCH, and receive, from the second UE, the S-PRS on the PSSCH based on the second SCI.

In accordance with another aspect of the disclosure, a method performed by a second UE in a wireless communication system is provided. The method includes transmitting, to a first UE, first SCI on a PSCCH, the first SCI including an SCI format field for a second SCI, in case that the SCI format field includes a first value corresponding to an SCI format for a sidelink (SL) positioning reference signal (PRS) for a shared SL PRS resource pool, transmitting, to the first UE, the second SCI corresponding to the SCI format on a PSSCH and transmitting, to the first UE, the SL PRS on the PSSCH based on the second SCI.

In accordance with another aspect of the disclosure, a second UE in a wireless communication system is provided. The second UE includes a transceiver and a controller coupled with the transceiver and configured to transmit, to a first UE, first SCI on a PSCCH, the first SCI including an SCI format field for a second SCI, in case that the SCI format field includes a first value corresponding to an SCI format for a sidelink (SL) positioning reference signal (PRS) for a shared SL PRS resource pool, transmit, to the first UE, the second SCI corresponding to the SCI format on a PSSCH, and transmit, to the first UE, the SL PRS on the PSSCH based on the second SCI.

According to an embodiment of the disclosure, it is possible to provide an apparatus and a method for effectively providing a service in a wireless communication system.

The disclosure proposes a method and a procedure in which a UE performs positioning (location measurement), and the proposed method and procedure enable positioning to be effectively performed.

Advantageous effects obtainable from the disclosure may not be limited to the above-mentioned effects, and other effects which are not mentioned may be clearly understood from the following descriptions by those skilled in the art to which the disclosure pertains.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a system according to an embodiment;

FIG. 1B illustrates a system according to an embodiment;

FIG. 1C illustrates a system according to an embodiment;

FIG. 2A illustrates a communication method performed through an SL according to an embodiment;

FIG. 2B illustrates a communication method performed through an SL according to an embodiment;

FIG. 3 illustrates a resource pool defined as a set (or a group) of resources on time and frequency used for SL transmission and reception according to an embodiment;

FIG. 4A illustrates an operation for calculating a location of a UE through an SL according to an embodiment;

FIG. 4B illustrates an operation for calculating a location of a UE through an SL according to an embodiment;

FIG. 4C illustrates an operation for calculating a location of a UE through an SL according to an embodiment;

FIG. 5A illustrates an operation for calculating a location of a UE through an SL according to an embodiment;

FIG. 5B illustrates an operation for calculating a location of a UE through an SL according to an embodiment;

FIG. 5C illustrates an operation for calculating a location of a UE through an SL according to an embodiment;

FIG. 6A illustrates an operation for calculating the location of a UE through an SL according to an embodiment;

FIG. 6B illustrates an operation for calculating the location of a UE through an SL according to an embodiment;

FIG. 6C illustrates an operation for calculating the location of a UE through an SL according to an embodiment;

FIG. 7A illustrates sidelink round trip time (SL-RTT), sidelink reference signal time difference (SL-RSTD), sidelink relative time of arrival (SL-RTOA), and/or sidelink angle of arrival (SL-AoA) according to an embodiment of the disclosure;

FIG. 7B illustrates SL-RTT, SL-RSTD, SL-RTOA, and/or SL-AoA according to an embodiment of the disclosure;

FIG. 7C illustrates SL-RTT, SL-RSTD, SL-RTOA, and/or SL-AoA according to an embodiment of the disclosure;

FIG. 7D illustrates SL-RTT, SL-RSTD, SL-RTOA, and/or SL-AoA according to an embodiment of the disclosure;

FIG. 8A illustrates a method of configuring S-PRS resource information 1, according to an embodiment;

FIG. 8B illustrates a method of configuring S-PRS resource information 1, according to an embodiment;

FIG. 8C illustrates a method of configuring S-PRS resource information 1, according to an embodiment;

FIG. 9A illustrates a method of determining a symbol area in which an S-PRS is transmitted within a time area configured for an SL operation, according to an embodiment;

FIG. 9B illustrates a method of determining a symbol area in which an S-PRS is transmitted within a time area configured for an SL operation, according to an embodiment;

FIG. 9C illustrates a method of determining a symbol area in which an S-PRS is transmitted within a time area configured for an SL operation, according to an embodiment;

FIG. 10A illustrates a comb pattern of an S-PRS according to an embodiment;

FIG. 10B illustrates a comb pattern of an S-PRS according to an embodiment;

FIG. 10C illustrates a comb pattern of an S-PRS according to an embodiment;

FIG. 10D illustrates a comb pattern of an S-PRS according to an embodiment;

FIG. 10E illustrates a comb pattern of an S-PRS according to an embodiment;

FIG. 10F illustrates a comb pattern of an S-PRS according to an embodiment;

FIG. 11A illustrates a method of configuring S-PRS resource information 1, according to an embodiment;

FIG. 11B illustrates a method of configuring S-PRS resource information 1, according to an embodiment;

FIG. 12A illustrates a case in which S-PRS resources are time division multiplexed (TDMed) within a slot in a method of configuring S-PRS resource information 1, according to an embodiment;

FIG. 12B illustrates a case in which S-PRS resources are TDMed within a slot in a method of configuring S-PRS resource information 1, according to an embodiment;

FIG. 12C illustrates a case in which S-PRS resources are TDMed within a slot in a method of configuring S-PRS resource information 1, according to an embodiment;

FIG. 13 illustrates a UE according to an embodiment; and

FIG. 14 illustrates a base station according to an embodiment.

### DETAILED DESCRIPTION

Hereinafter, various embodiments of the disclosure will be described in detail with reference to the accompanying drawings.

In describing the embodiments of the disclosure, descriptions related to technical contents well-known in the relevant art and not associated directly with the disclosure will be omitted. Such an omission of unnecessary descriptions is intended to prevent obscuring of main ideas of the disclosure and more clearly transfer the main ideas.

In the accompanying drawings, some elements may be exaggerated, omitted, or schematically illustrated. Furthermore, the size of each element does not completely reflect the actual size. In the respective drawings, identical or corresponding elements may be provided with identical or similar reference numerals.

Although certain advantages and features of the disclosure and ways to achieve them will be apparent by making reference to embodiments as described below in detail in conjunction with the accompanying drawings, the disclosure is not limited to the embodiments set forth below, but may be implemented in various different forms, and the embodiments of the disclosure are provided merely to completely disclose the disclosure and inform those skilled in the art of the scope of the disclosure. The disclosure is defined only by the scope of the appended claims.

Each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or any other programmable data processing apparatus to cause a series of operational steps to be performed on the computer or any other programmable data processing apparatus to produce a computer implemented process. The instructions executed on the computer or any other programmable data processing apparatus provide steps for implementing the functions specified in the flowchart block or blocks.

Furthermore, each block in the flowchart illustrations may represent a module, segment, or portion of code, which includes one or more executable instructions for implementing the specified logical function(s). In various embodiments, the functions noted in the blocks may occur out of the order. For example, two blocks shown in succession may in fact be executed substantially concurrently or the blocks may sometimes be executed in the reverse order, depending upon the functionality involved.

As used herein, the “unit” may refer to a software element or a hardware element, such as a field programmable gate array (FPGA) or an application specific integrated circuit (ASIC), which performs a predetermined function. However, the term “unit” does not always have a meaning limited to software or hardware. A “unit” may be constructed either to be stored in an addressable storage medium or to execute one or more processors. Therefore, a “unit” may include, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Further, a “unit” may include one or more processors.

Although embodiments of the disclosure are mainly described below with reference to NR as a radio access network and packet core (e.g., 5G system, 5G core network, or next generation core (NG Core)) as a core network in the 5G mobile communication standards specified by the 3rd generation partnership project (3GPP), the disclosure may also be applied to other communication systems having similar backgrounds through some modifications without significantly departing from the scope of the disclosure. The modifications within the scope of the disclosure may be possible based on determinations by those skilled in the art.

In a 5G system, a network data collection and analysis function (NWDAF) for analyzing and providing data collected in a 5G network may be defined to support network automation. For example, the NWDAF may collect/store/analyze information from the 5G network and provide the results to unspecified network functions (NFs), and the analysis results may be used independently in each NF.

In the following description, some of terms and names defined in the 3GPP standards (standards for 5G, NR, long term evolution (LTE), or similar systems) may be used for descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, etc., are illustratively used for descriptive convenience. Therefore, the disclosure is not limited by the terms as used herein, and other terms referring to subjects having equivalent technical meanings may be used.

To meet the increasing demand for wireless data traffic since deployment of 4th generation (4G) communication systems, efforts have been made to develop an improved 5G communication system NR). The 5G communication system has been designed to support ultrahigh frequency (mmWave) bands (e.g., 28 GHz frequency bands) so as to accomplish higher data rates. To decrease propagation loss of the radio waves and increase the transmission distance in the ultrahigh frequency bands, beamforming, massive MIMO, FD-MIMO, array antenna, analog beam forming, large scale antenna techniques are under discussion in the 5G communication systems.

Unlike in LTE, in the 5G communication systems, various subcarrier spacings including 15 kHz, 30 kHz, 60 kHz, and 120 kHz are supported, physical control channels use polar coding, and physical data channels use LDPC.

Furthermore, as waveforms for uplink transmission, cyclic prefix-orthogonal frequency division multiplexing (CP-OFDM) and discrete Fourier transform-spread-orthogonal frequency division multiplexing (DFT-S-OFDM) are used.

While hybrid automatic repeat request (HARQ) retransmission in units of transport blocks (TBs) are supported in LTE, HARQ retransmission based on a code block group (CBG) including a bundle of a plurality of code blocks (CBs) may be additionally supported in 5G.

In addition, in the 5G communication system, technical development for system network improvement is under way based on evolved small cells, advanced small cells, cloud radio access networks (RANs), ultra-dense networks, device-to-device (D2D) communication, wireless backhaul, moving network, cooperative communication, coordinated multi-points (CoMPs), reception-end interference cancellation, etc.

The Internet is also evolving to the Internet of things (IoT), where distributed entities, i.e., things, exchange and process information without human intervention. For example, the Internet of everything (IoE), which is a combination of the IoT technology and the big data processing technology through a connection with a cloud server, etc., has emerged.

As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), etc., have also been researched. Such an IoT environment may provide intelligent Internet technology services that create a new value to human life by collecting and analyzing data generated among connected things. IoT may be applied to a variety of fields including smart homes, smart buildings, smart cities, smart or connected cars, smart grid, health care, smart appliances and advanced medical services through convergence and combination between existing information technology (IT) and various industrial applications.

In line with this, various attempts have been made to apply the 5G communication system to IoT networks. For example, technologies such as a sensor network, MTC, and M2M communication are implemented by beamforming, MIMO, and array antenna techniques that are 5G communication technologies.

Application of a cloud RAN as the above-described big data processing technology may also be considered an example of convergence of the 5G technology with the IoT technology.

As described above, a communication system may provide multiple services to a user, and in order to provide these multiple services to a user, there is a need for a method that can provide each service in the same time interval according to the characteristics thereof and a device using the same. Various services to be provided in 5G communication systems are being studied, and one of them is a service that satisfies requirements for low latency and high reliability.

Furthermore, demands for mobile services are explosively increasing, and a location-based service (LBS) led by two requirements including an emergency service and a commercial application is rapidly developing. For example, in the case of communication using an SL, an NR SL system supports UE-to-UE unicast communication, groupcast (or multicast) communication, and broadcast communication. In addition, unlike LTE SL, which aims to transmit and receive basic safety information necessary for road driving of vehicles, NR SL aims to provide more advanced services such as platooning, advanced driving, extended sensors, and remote driving.

In an NR SL, positioning (e.g., location measurement) may be performed through an SL between UEs. That is, a method of measuring the location of a UE using a positioning signal transmitted through an SL may be considered.

A method of measuring a location of a UE using a positioning signal transmitted through a downlink and an uplink between the UE and a base station is possible only when the UE is within the coverage of the base station. However, when SL positioning is introduced, the location of a UE may be measured even when the UE is outside the coverage of a base station. In a sidelink, a positioning signal may be referred to as a sidelink positioning reference signal (S-PRS). However, an S-PRS may be referred to by other terms. In accordance with an embodiment of the disclosure, a method of transmitting an S-PRS according to a positioning method supported in an SL is provided.

For example, a method of selecting a resource and configuring a resource location for signal transmission and transmitting a related control signal with an S-PRS is provided. A UE receiving the S-PRS may perform measurement on the S-PRS. A positioning method considered in an SL may consider an SL-RTT, an SL-RSTD, an SL-RTOA, and/or an SL-AoA. The UE may calculate a location coordinate or the distance between UEs through the measurement.

An embodiment of the disclosure is proposed to support the foregoing scenario, and may provide a method and an apparatus for measuring the location of a UE (positioning).

The disclosure relates to a wireless mobile communication system and, more particularly, to a method and an apparatus for performing positioning (location measurement. Specifically, methods for performing positioning through a sidelink are proposed. However, content proposed in the disclosure is not applicable only to a sidelink.

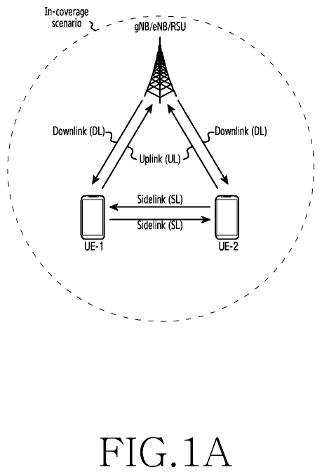

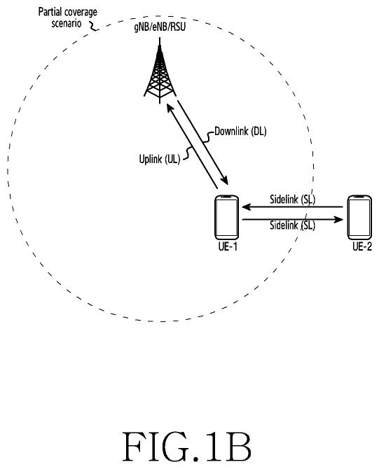

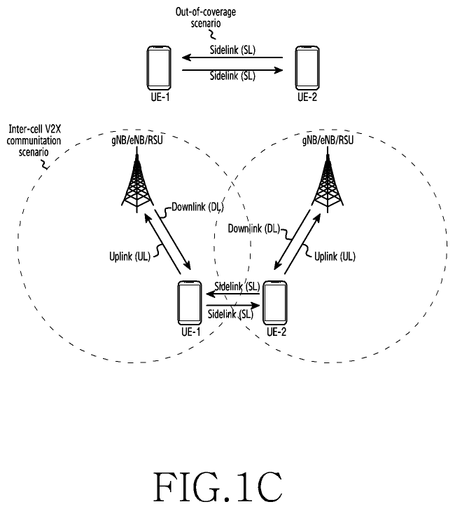

FIG. 1A illustrates a system according to an embodiment, FIG. 1B illustrates a system according to an embodiment, and FIG. 1C illustrates a system according to an embodiment. Referring to FIG. 1A, all UEs (i.e., UE-1 and UE-2) communicating through an SL are located within the coverage of a base station (i.e., an in-coverage scenario). All UEs may receive data and control information from the base station through a downlink (DL), or may transmit data and control information to the base station through an uplink (UL). For example, the data and the control information may be data and control information for SL communication. The data and the control information may be data and control information for general cellular communication. Further, the UE-1 and UE-2 may transmit and/or receive data and control information for SL communication through an SL.

FIG. 1B illustrates a system according to an embodiment.

Referring to FIG. 1B, a UE-1 among UEs is located within the coverage of a base station and a UE-2 is located outside the coverage of the base station. That is, FIG. 1B illustrates an example of partial coverage scenario in which UE-2 is located outside the coverage of the base station. As UE-1 is located within the coverage of the base station, it may receive data and control information from the base station through a downlink, or may transmit data and control information to the base station through an uplink. However, because UE-2 is located outside the coverage of the base station, it is unable to receive data and control information from the base station through the downlink, and is unable to transmit data and control information to the base station through the uplink. UE-2 may transmit and/or receive data and control information for SL communication to and/or from UE-1 through an SL.

FIG. 1C illustrates a system according to an embodiment.

Referring to FIG. 1C, in case of an out-of-coverage scenario, both UE-1 and UE-2 are located outside the coverage of a base station (i.e., an out-of-coverage scenario). Therefore, UE-1 and UE-2 are unable to receive data and control information from the base station through a downlink, and are unable to transmit data and control information to the base station through an uplink. However, UE-1 and UE-2 may transmit and/or receive data and control information through an SL.

Referring to FIG. 1C, in case of an inter-cell V2X communication scenario, SL communication is performed between UE-1 and UE-2, which are located in different cells. More specifically, UE-1 and UE-2 are connected to different base stations (i.e., an radio resource control (RRC)-connected state) or camp on the different base stations (i.e., an RRC-disconnected state, or an RRC idle state). In an SL, UE-1 may be a transmission UE, and UE-2 may be a reception UE, or UE-1 may be a reception UE, and UE-2 may be a transmission UE. UE-1 may receive a system information block (SIB) from a base station which UE-1 is connected to (or camps on), and UE-2 may receive an SIB from a different base station which UE-2 is connected to (or camps on). In this case, the SIBs may be an existing SIB or an SIB separately defined for SL communication. Information of the SIB received by UE-1 and information of the SIB received by UE-2 may be different from each other. Therefore, the pieces of information should be unified to perform SL communication between the UE-1 and UE-2 located in the different cells, or a method of signaling information thereabout and interpreting the pieces of SIB information transmitted from the different cells may be added.

Although FIG. 1A to FIG. 1C illustrate an SL system including two UEs (i.e., UE-1 and UE-2) for convenience of explanation, the disclosure is not limited thereto, and communication may be performed between a greater number of UEs.

An interface (uplink and downlink) between a base station and UEs may be referred to as a Uu interface, and an SL communication between UEs may be referred to as a PC5 interface. The foregoing terms may be interchangeably used in the disclosure.

Herein, a UE may refer to a general UE and/or a UE supporting a V2X UE. For example, a UE may refer to a handset (i.e., a smartphone) of a pedestrian, or a UE may include a vehicle supporting vehicle-to-vehicle (V2V) communication, a vehicle supporting vehicle-to-pedestrian (V2P) communication, a vehicle supporting vehicle-to-network (V2N) communication, and/or a vehicle supporting vehicle-to-infrastructure (V2I) communication. Further, a UE may include a roadside unit (RSU) including a UE function, an RSU including a base station function, and/or an RSU including part of a base station function and part of a UE function.

A base station may support both V2X communication and general cellular communication, or only V2X communication. For example, a base station may be a 5G base station (gNB), a 4G base station (eNB), and/or an RSU. Accordingly, a base station may be referred to as an RSU.

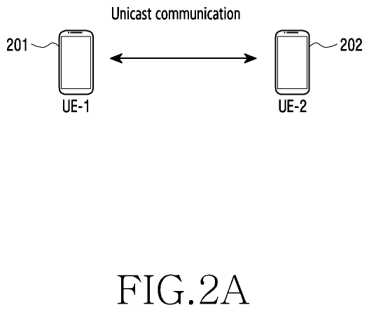

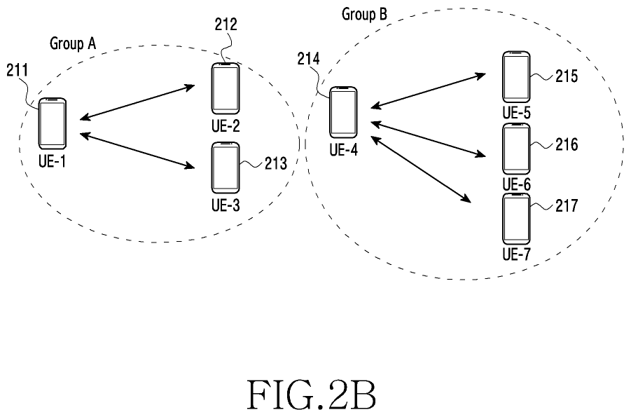

FIG. 2A illustrates a communication method performed through an SL according to an embodiment.

Referring to FIG. 2A, UE-1 201 (e.g., a TX UE) and UE-2 202 (e.g., an RX UE) may perform one-to-one communication, and one-to-one communication between UE-1 and UE-2 may be referred to as unicast communication.

UE-1 and UE-2 may exchange capability information and configuration information through PC5-RRC defined in a unicast link between the UEs in an SL. In another example, UE-1 and UE-2 may exchange configuration information through an SL medium access control (MAC) control element (CE) defined in the unicast link between the UEs. The configuration information may include destination identifier (ID) and source ID information. However, an information exchange method for unicast is not limited to the PC5-RRC and the MAC-CE.

Related information (e.g., information for the SL) may be included in SCI. For example, the SCI may be first SCI and/or second SCI. Further, some of the related information may be included in the SCI and transmitted, and the other thereof may be included in a different channel and transmitted through the PC5-RRC or MAC-CE.

FIG. 2B illustrates a communication method performed through an SL according to an embodiment.

Referring to FIG. 2B, a TX UE and an RX UE may perform one-to-many communication, which may be referred to as groupcast or multicast.

For example, in FIG. 2B, UE-1 211, UE-2 212, and/or UE-3 213 may form one group (group A) to perform groupcast communication, and UE-4 214, UE-5 215, UE-6 216, and/or UE-7 217 may form another group (group B) to perform groupcast communication. Each UE may perform groupcast communication only within a group to which the UE belongs, and communication between different groups may be performed through unicast communication, groupcast communication, or broadcast communication. Although FIG. 2B illustrates that two groups are formed, the disclosure is not limited thereto.

Although not shown in FIGS. 2A and 2B, UEs may perform broadcast communication in an SL. Broadcast communication refers to a case in which all UEs receive data and control information transmitted by a transmission UE through an SL. For example, in FIG. 2B, assuming UE-1 211 as a transmission UE for broadcast, UE-2 212, UE-3 213, UE-4 214, UE-5 215, UE-6 216, and/or UE-7 217 may receive data and control information transmitted by UE-1 211.

Unlike LTE V2X, NR V2X may support communication in which a vehicle UE transmits data to one specific node through unicast and communication in which a vehicle UE transmits data to a plurality of specific nodes through groupcast. For example, unicast and groupcast technologies may be useful in a service scenario, such as platooning, which is a technique for driving two or more vehicles in a group by connecting the vehicles via one network. For example, a leader node of a group connected through platooning may need unicast communication to control one specific node, and may need groupcast communication to control the group of a plurality of specific nodes simultaneously.

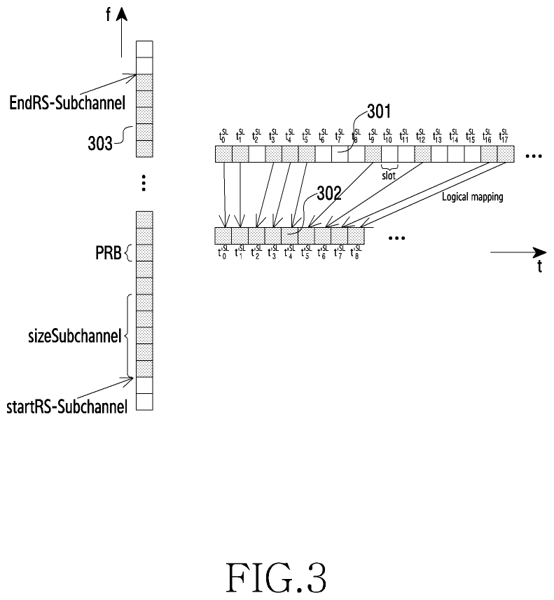

FIG. 3 illustrates a resource pool defined as a set (or group) of resources on time and frequency used for SL transmission and reception according to an embodiment.

Referring to FIG. 3, in the resource pool, resource granularity on a time axis may be a slot. Resource granularity on a frequency axis may be a subchannel including one or more physical resource blocks (PRBs). Although the disclosure illustrates an example in which a resource pool is discontinuously allocated in time, a resource pool may be continuously allocated in time. Further, although the disclosure illustrates an example in which a resource pool is continuously allocated in frequency, a method in which a resource pool is discontinuously allocated in frequency is not excluded.

FIG. 3 illustrates a case 301 in which a resource pool is discontinuously allocated in time, and a case in which resource granularity in time is a slot. An SL slot may be defined within slots used for an uplink. For example, the length of a symbol used for an SL within one slot may be configured for SL BWP information. Therefore, among the slots used for the uplink, slots in which the length of a symbol configured for the SL is not guaranteed may not be SL slots. Further, a slot where an SL synchronization signal block (S-SSB) is transmitted may be excluded from slots belonging to the resource pools.

Referring to a set of slots 301, excluding these slots, a set (group) of slots available for the SL in time is shown as t₀^{SL}, t₁^{SL}, t₂^{SL}, etc. The shaded portions in the set of slots 301 may represent SL slots belonging to the resource pool. The SL slots belonging to the resource pool may be preconfigured with resource pool information through a bitmap.

Referring to a set of SL slots 302, the set (group) of SL slots belonging to the resource pool in time is shown as t′₀^{SL}, t′₁^{SL}, t′₂^{SL}, etc. A (pre) configuration may mean configuration information preconfigured and stored in a UE, or may mean that a UE is configured by a cell-common method from a base station. For example, cell-common may mean that UEs in a cell receive the same information configuration from a base station. In this case, the UEs may receive an SL-SIB from the base station, thus obtaining cell-common information.

In another example, a (pre) configuration may refer to a UE that is configured by a UE-specific method after establishing an RRC connection with a base station. For example, UE-specific may be replaced with UE-dedicated, and may mean that each UE receives configuration information with a specific value. In this case, the UE may receive an RRC message from the base station, thereby obtaining UE-specific information.

In still another example, a method of configuring a (pre) configuration as resource pool information and a method of not configuring a (pre) configuration in resource pool information may be considered. In a case of the (pre) configuration as the resource pool information, all UEs operating in a resource pool may operate with common configuration information except for a case in which a UE is configured by a UE-specific method after establishing an RRC connection with a base station.

A method of not configuring the (pre) configuration in the resource pool information is basically a method of configuring the (pre) configuration) independently of resource pool configuration information. For example, the (pre) configuration may be configured as SL BWP information and applied equally to all resource pools. In another example, one or more modes (e.g., A, B, and C) are (pre) configured in a resource pool, and a mode (e.g., A, B, or C) to be used among the modes (pre) configured in the resource pool may be indicated through information (pre) configured independently of resource pool configuration information.

Further, in SL unicast transmission, a (pre) configuration may be configured through PC5-RRC.

Alternatively, a method of configuring a (pre) configuration through MAC-CE may also be considered. A (pre) configuration in the disclosure means that all of the foregoing cases are applicable.

Referring to 303 of FIG. 3, a case in which a resource pool is continuously allocated in frequency is shown. Resource allocation on the frequency axis may be configured with SL BWP information, and be performed on a unit of a subchannel. A subchannel may be defined as a resource allocation unit including one or more PRBs in frequency. That is, a subchannel may be defined as an integer multiple of a PRB.

Referring to 303, a subchannel may include five consecutive PRBs, and a subchannel size (sizeSubchannel) may be the size of five consecutive PRBs. However, content shown in the drawing is only an example of the disclosure, and the subchannel size may be configured differently. One subchannel generally includes consecutive PRBs, but not necessarily includes consecutive PRBs. A subchannel may be a basic unit of resource allocation for a PSSCH.

Referring to 303, startRB-Subchannel may indicate the start position of a subchannel in frequency in the resource pool. When resource allocation is performed by a unit of a subchannel on the frequency axis, a resource in frequency may be allocated based on the index (startRB-Subchannel) of a resource block (RB) where the subchannel starts, information (sizeSubchannel) about the number of PRBs included in the subchannel, and/or configuration information about the total number (numSubchannel) of subchannels. Here, the information about startRB-Subchannel, sizeSubchannel, and numSubchannel may be (pre) configured as frequency resource pool information.

A methods for allocating a transmission resource in an SL includes a method in which a UE is allocated an SL transmission resource from a base station when the UE is within the coverage of the base station. Hereinafter, this method is referred to as mode 1. For example, mode 1 may include a method in which a base station allocates a resource used for SL transmission to RRC-connected UEs by a dedicated scheduling method. The method of mode 1 may be effective for interference management and resource pool management since the base station may manage an SL resource.

In another example, among the methods for allocating the transmission resource in the SL, there is a method in which a UE directly allocates a transmission resource through sensing in the SL. Hereinafter, this method is referred to as mode 2. Mode 2 may be referred to as UE autonomous resource selection. Unlike mode 1 in which the base station is directly involved in resource allocation, mode 2 allows a transmission UE to autonomously select a resource through sensing and a resource selection procedure defined based on a (pre) configured resource pool and to transmit data through the selected resource.

When a transmission resource is allocated through mode 1 or mode 2, a UE may transmit and/or receive data and control information through an SL. For example, the control information may include SCI format 1-A as first-stage SCI transmitted through a PSCCH. In another example, the control information may include at least one of SCI format 2-A or SCI format 2-B as second-stage SCI transmitted through a PSSCH.

Hereinafter, as a positioning method for measuring the location of a UE, a method using a positioning signal (i.e., a PRS) transmitted through a downlink and an uplink between a UE and a base station is described. In the disclosure, the method using the positioning signal transmitted through the downlink and the uplink between the UE and the base station may be referred to as radio access technology (RAT)-dependent positioning.

Other positioning methods may also be classified as RAT-independent positioning. For example, in an LTE system, as an RAT-dependent positioning technique, observed time difference of arrival (OTDOA), uplink time difference of arrival (UL-TDOA), and/or enhanced cell identification (E-CID) methods may be used.

In an NR system, downlink time difference of arrival (DL-TDOA), downlink angle of departure (DL-AOD), multi-round trip time (Multi-RTT), NR E-CID, UL-TDOA, and/or uplink angle of arrival (UL-AOA) methods may be used. A RAT-independent positioning technique may include assisted global navigation satellite system (A-GNSS), sensor, and wireless local area network (WLAN), and/or Bluetooth methods.

The disclosure focuses specifically on a RAT-dependent positioning method supported through an SL. In an interface (e.g., a Uu) between a base station and UEs, RAT-dependent positioning is possible when a UE is within the coverage of the base station. However, SL RAT-dependent positioning may not be limited to a case where a UE is within the coverage of a base station. In RAT-dependent positioning in a Uu, a positioning protocol, such as an LTE positioning protocol (LPP), an LTE positioning protocol annex (LPPa), and an NR positioning protocol annex (NRPPa), may be used. The LPP may be referenced as a positioning protocol defined between a UE and a location server (LS). The LPPa and the NRPPa may be referred to as a protocol defined between a base station and the LS. For example, the LS is an entity that manages location measurement, and may serve as a location management function (LMF). The LS may also be referred to as an LMF or another term. In both the LTE system and the NR system, the LPP is supported, and at least one of the following functions for positioning may be performed through the LPP.
Exchange of positioning capability
Transfer of assistance data
Transfer of location information
Error handling
Abort

The UE and the LS may perform the foregoing functions through the LPP, and the base station may function to allow the UE and the LS to exchange positioning information. For example, exchange of positioning information through the LPP may be performed transparently to the base station. That is, the base station may not be involved in exchanging the positioning information between the UE and the LS.

In the exchange of positioning capability, UE-supportable positioning information may be exchanged with the LS. For example, the UE-supportable positioning information may indicate whether a positioning method supported by the UE is a UE-assisted method, a UE-based method, or both of the methods. For example, the UE-assisted method refers to a method in which the UE does not directly measure the absolute location of the UE but transmits only a measured value for a positioning technique to the LS, based on an applied received positioning signal and the LS calculates the absolute location of the UE. For example, the absolute location may refer to two-dimensional (x, y) and three-dimensional (x, y, z) coordinate location information about the UE by longitude and latitude. The UE-based method may be a method in which the UE directly measures the absolute location of the UE, for which the UE may need to receive a positioning signal and also be provided with location information about an entity that transmitting the positioning signal.

While only the UE-assisted method is supported in the LTE system, both UE-assisted positioning and UE-based positioning may be supported in the NR system.

Transfer of assistance data may be an important element in positioning when measuring the accurate location of the UE. For example, in the transfer of assistance data, the LS may provide the UE with configuration information about a positioning signal and information about a candidate cell and/or a transmission-reception point (TRP) to receive the positioning signal. For example, when DL-TDOA is used, the information about the candidate cell and the TRP to receive the positioning signal may include information about a reference cell, a reference TRP, a neighbor cell, and/or a neighbor TRP. Further, information indicating that a plurality of candidates for a neighbor cell and a neighbor TRP is provided and a cell and a TRP to be selected by the UE to measure the positioning signal may also be provided. To measure the accurate location, the UE should properly select information about a reference candidate cell and TRP. For example, as a channel for a positioning signal received from the candidate cell and TRP is more line-of-site (LOS), i.e., as the channel has fewer non-LOS (NLOS) channel components, the accuracy of positioning measurement may increase. Therefore, when the LS collects various information to provide the UE with information about candidate cells and TRPs for reference to perform positioning, the UE may perform more accurate positioning measurement.

Transfer of location information may be performed through the LPP. For example, the LS may request location information from the UE, and the UE may provide location information measured according to a location information request to the LS. In the UE-assisted method, the location information may be the measured value for the positioning technique based on the received positioning signal. In the UE-based method, the location information may be the two-dimensional (x, y) and three-dimensional (x, y, z) coordinate location values of the UE. The LS may include required accuracy and response time as positioning quality-of-service (QOS) information when requesting the location information from the UE. When the positioning QoS information is requested, the UE may need to provide the LS with location information measured to satisfy the accuracy and response time. When it is impossible to satisfy QoS, error handling and abort may be considered. However, this example is only for illustration, and error handling and abort for positioning may be performed in other cases in addition to the case where it is impossible to satisfy QoS.

A positioning protocol defined between the base station and the LS may be referred to as the LPPa in the LTE system, and at least one of the following functions may be performed between the base station and the LS.
Transfer of E-CID location information
Transfer of OTDOA information
Report of general error state
Transfer of assistance information

A positioning protocol defined between the base station and the LS may be referred to as the NRPPa in the NR system, and at least one of the following functions may be performed between the base station and the LS in addition to the foregoing functions performed by the LPPa.
Transfer of positioning information
Transfer of measurement information
Transfer of TRP information

In the NR system, unlike the LTE system, a greater number of positioning techniques are supported. Therefore, various positioning techniques may be supported through transfer of positioning information. For example, it is possible for the base station to perform positioning measurement through a sound reference signal transmitted by the UE. Therefore, as positioning information, a positioning sounding reference signal (SRS) configuration and activation/deactivation-related information may be exchanged between the base station and the LS.

Transfer of measurement information may refer to a function of exchanging information related to multi-RTT, UL-TDOA, and/or UL-AOA, which is not supported in the LTE system, between the base station and the LS. In transfer of TRP information, since positioning is performed based on a cell in the LTE system but positioning may be performed based on a TRP in the NR system, information related to positioning performed based on a TRP may be exchanged.

Entities that perform a positioning-related configuration and entities that calculate positioning to measure the location of a UE in an SL may be divided into three cases as follows.
UE (no LS)
LS (through BS)
LS (through UE)

The LS refers to a LS, the BS refers to a base station, such as a gNB or an eNB, and the UE refers to a terminal that performs transmission and reception through an SL. For example, the UE that performs transmission and/or reception through the sidelink may be a vehicle UE and a pedestrian UE. In another example, the UE that performs transmission and/or reception through the sidelink may be an RSU having a UE function, an RSU having a base station function, or an RSU having part of a base station function and part of a UE function. For example, the UE that performs transmission and/or reception through the sidelink may include a positioning reference unit (PRU) at a known location of the UE.

The UE (no LS) refers to an SL UE having no connection to a LS. The LS (through BS) is a LS, and refers to a LS connected to a base station. The LS (through UE) is a LS, and refers to a LS connected to an SL UE. That is, the LS (through UE) may correspond to a case in which the LS is available even though a UE is not within the coverage of a base station. Here, the LS (through UE) may be available only to a specific terminal, such as an RSU or a PRU, other than a general UE. In an SL, a UE connected to a LS may be defined as a new type of device. Further, only a specific UE supporting a UE capability to connect to a LS may perform a function of connecting to a LS through an SL.

Cases 1 to 9 in Table 1 below show various combinations of entities that perform a positioning-related configuration and entities that calculate positioning to measure the location of a UE in an SL.

A UE of which the location needs to be measured is referred to as a target UE. A UE of which the location is known or which may provide a positioning signal to measure the location of the target UE is referred to as an anchor UE. Therefore, the anchor UE may have location information thereof, and may provide the location information about the UE along with an S-PRS. That is, the anchor UE may be a (known-location) UE which knows the location thereof. However, the anchor UE may be a (unknown-location) UE which does not know the location thereof. When the anchor UE is a (known-location) UE which knows the location thereof, the location information may be transmitted to the target UE, and the target UE may perform UE-based positioning.

The terms “target UE” and “anchor UE” may be replaced with other terms. For example, the anchor UE may be referred to as a positioning reference (PosRef) UE. Positioning configurations may be divided into a UE-configured method and a network-configured method.

In Table 1, a positioning configuration of a UE (no LS) may correspond to the UE-configured method. In the UE-configured method, positioning configuration is possible even when a UE is not within the coverage of a network (base station).

In Table 1, a positioning configuration of an LS (through BS) may correspond to the network-configured method. In the network-configured method, since a UE is within the coverage of a network and reports positioning calculation and measurement information to a base station and thus a LS connected to the base station measures the location of the target UE, a delay may occur due to signaling related to location measurement but accurate location measurement may be possible.

In Table 1, a positioning configuration of an LS (through UE) is not a method in which a UE is not configured through a base station within the coverage of a network, and may thus not be classified as the network-configured method. Further, a case in which a LS connected to a UE provides a configuration but the configuration is not classified as a configuration by the UE may not be classified as the UE-configured method. However, a case in which the configuration is classified as a configuration by the UE may be classified as the UE-configured method. Therefore, the case of the LS (through UE) may be referred to as a method other than the UE-configured or network-configured method.

Positioning calculations may be divided into two UE-assisted and UE-based methods as described above. In Table 1, a positioning calculation of a UE (no LS) may correspond to the UE-based method, and a positioning calculation of an LS (through BS) or LS (through UE) may generally correspond to the UE-assisted method. However, when a positioning calculation is an LS (through UE) and the LS is interpreted as a UE, the LS (through UE)) may be classified as UE-based.

TABLE 1

| | Positioning configuration | Positioning calculation |
|---|---|---|
| Case 1 | UE (no LS) | UE (no LS) |
| Case 2 | UE (no LS) | LS (through BS) |
| Case 3 | UE (no LS) | LS (through UE) |
| Case 4 | LS (through BS) | UE (no LS) |
| Case 5 | LS (through BS) | LS (through BS) |
| Case 6 | LS (through BS) | LS (through UE) |
| Case 7 | LS (through UE) | UE (no LS) |
| Case 8 | LS (through UE) | LS (through BS) |
| Case 9 | LS (through UE) | LS (through UE) |

In Table 1, positioning configuration information may include S-PRS configuration information. For example, the S-PRS configuration information may include pattern information and time/frequency transmission location-related information about an S-PRS. In positioning calculation in Table 1, a UE may receive an S-PRS and may perform measurement (e.g., positioning calculation) from the received S-PRS, and positioning measurement and calculation methods may vary depending on an applied positioning method.

For example, measurement of location information in an SL may be absolute positioning of providing two-dimensional (x, y) and three-dimensional (x, y, z) coordinate location values of a UE, and may be relative positioning of providing relative two-dimensional or three-dimensional location information from another UE. In the SL, location information may be ranging information simply including both or one piece information of the distance and direction from another UE. The meaning of ranging in the SL includes both distance and direction information, ranging may have the same meaning as relative positioning. As a positioning method, SL time difference of arrival (SL-TDOA), SL angle of departure (SL-AOD), SL multi-round trip time (SL Multi-RTT), SL round trip time (SL RTT), SL E-CID, and/or SL angle of arrival (SL-AOA) may be considered.

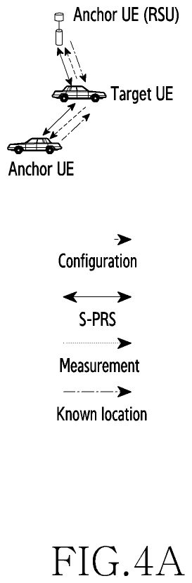

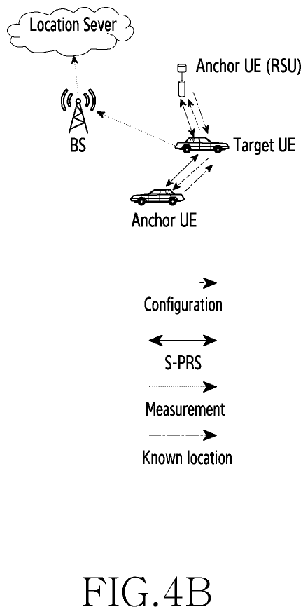

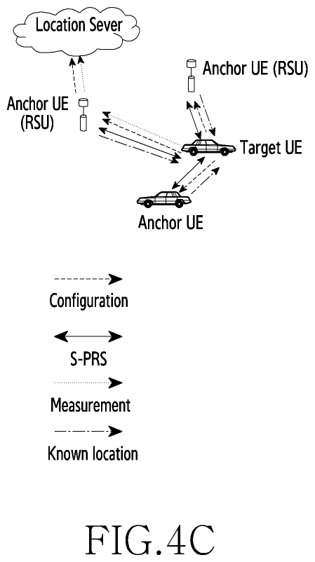

FIG. 4A illustrates a case of calculating the location of a UE through a sidelink according to an embodiment, FIG. 4B illustrates a case of calculating the location of a UE through a sidelink according to an embodiment, and FIG. 4C illustrates a case of calculating the location of a UE through a sidelink according to an embodiment.

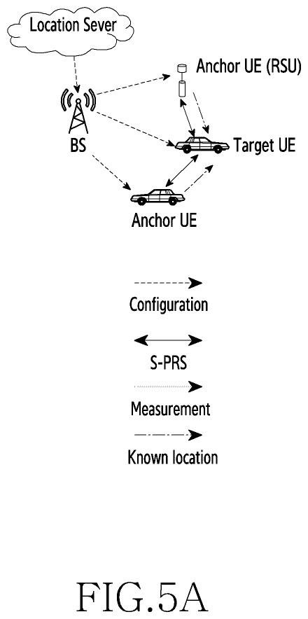

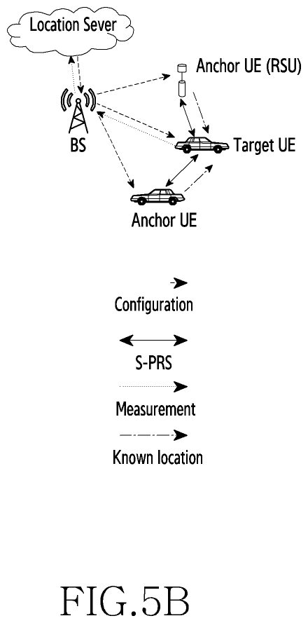

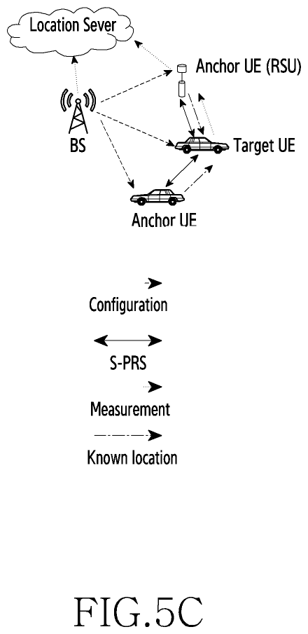

FIG. 5A illustrates a case of calculating the location of a UE through a sidelink according to an embodiment, FIG. 5B illustrates a case of calculating the location of a UE through a sidelink according to an embodiment, and FIG. 5C illustrates a case of calculating the location of a UE through a sidelink according to an embodiment.

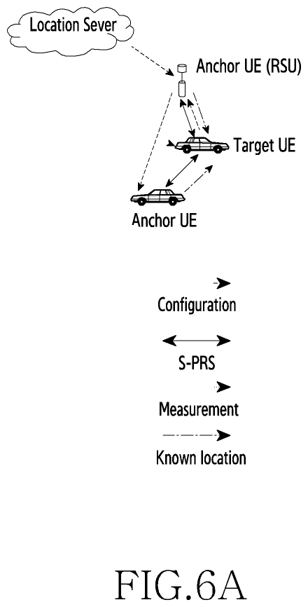

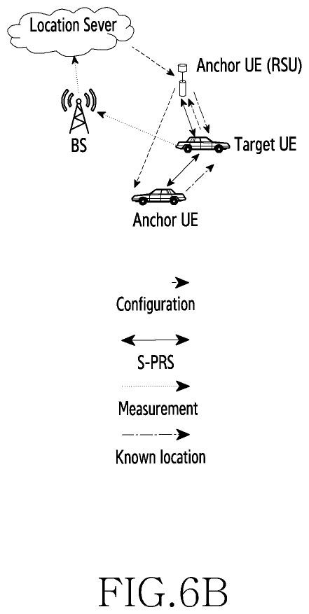

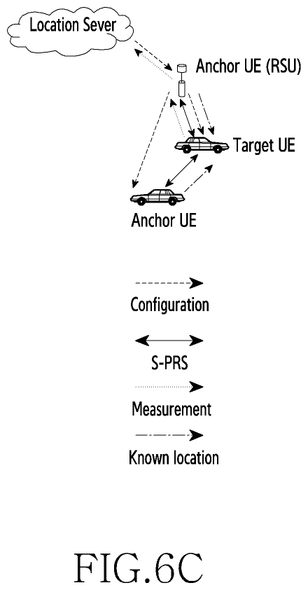

FIG. 6A illustrates a case of calculating the location of a UE through a sidelink according to an embodiment, FIG. 6B illustrates a case of calculating the location of a UE through a sidelink according to an embodiment, and FIG. 6C illustrates a case of calculating the location of a UE through a sidelink according to an embodiment.

In the disclosure, a case of calculating the location of a UE through a sidelink is not limited to the cases illustrated in FIG. 4A to FIG. 6C. In FIG. 4A to FIG. 6C, signaling of positioning configuration information is shown in a black dotted line. Transmission of an S-PRS is shown in a sky-blue dotted line. The transmission of the S-PRS may be performed in two directions or in one direction. Transmission of information measured for positioning or measured positioning information is shown in a red dotted line. Transmission of location information known to a UE (known location) is shown in a blue dotted line.

FIG. 4A illustrates an operation for calculating a location of a UE through a sidelink according to an embodiment.

Referring to FIG. 4A, an SL UE having no connection to an LS provides a positioning configuration and a target UE having no connection to the LS performs positioning calculation, which may correspond to case 1 in Table 1. In this case, the target UE may broadcast, unicast, or groupcast an instruction on positioning-related configuration information to other UEs through an SL. Further, the target UE may perform positioning calculation, based on a provided positioning signal.

FIG. 4B illustrates an operation for calculating a location of a UE through an SL according to an embodiment.

Referring to FIG. 4B, an SL UE having no connection to an LS provides a positioning configuration and a target UE is located within the coverage of a network. Thus, the LS connected to a base station performs positioning calculation, which may correspond to case 2 in Table 1. In this case, the target UE may broadcast, unicast, or groupcast an instruction on positioning-related configuration information to other UEs through an SL. Further, the target UE may perform positioning measurement, based on a provided positioning signal, and may report measured positioning information to the base station because the target UE is within the coverage of the base station. The reported measurement information may be reported to the LS connected to the base station, and the LS may perform positioning calculation.

FIG. 4C illustrates an operation for calculating a location of a UE through an SL according to an embodiment.

Referring to FIG. 4C, an SL UE having no connection to an LS provides a positioning configuration and the LS performs positioning calculation through an SL UE connected to the LS, which may correspond to case 3 in Table 1. In this case, a target UE may broadcast, unicast, or groupcast an instruction on positioning-related configuration information to other UEs through an SL. Further, the target UE may perform positioning measurement, based on a provided positioning signal, and may report measured positioning information to the UE connected to the LS because the target UE is within the coverage of an SL with the UE connected to the LS. Although FIG. 4C illustrates that the UE connected to the LS is an anchor UE (i.e., an RSU), the UE may be a UE instead of the RSU. Subsequently, the measured information may be reported to the LS connected to the anchor UE (RSU), and the LS may perform positioning calculation.

FIG. 5A illustrates an operation for calculating a location of a UE through an SL according to an embodiment.

Referring to FIG. 5A, an SL UE is located within the coverage of a network and thus an LS connected to a base station provides a positioning configuration and a target UE having no connection to the LS performs positioning calculation, which may correspond to case 4 in Table 1. In this case, the LS connected to the base station may provide positioning configuration information by using a positioning protocol, such as the LPP. Further, the target UE may perform positioning calculation, based on the provided configuration information and a provided positioning signal.

FIG. 5B illustrates an operation for calculating a location of a UE through an SL according to an embodiment.

Referring to FIG. 5B, an SL UE is located within the coverage of a network and thus an LS connected to a base station provides a positioning configuration and a target UE is located within the coverage of the network and the LS connected to the base station performs positioning calculation, which may correspond to case 5 in Table 1. In this case, the LS connected to the base station may provide positioning configuration information by using a positioning protocol, such as the LPP. The target UE may perform positioning measurement, based on the provided configuration information and a provided positioning signal, and may report measured positioning information to the base station because the target UE is within the coverage of the base station. The measured information may be reported to the LS connected to the base station, and the LS may perform positioning calculation.

FIG. 5C illustrates an operation for calculating a location of a UE through an SL according to an embodiment.

Referring to FIG. 5C, an SL UE is located within the coverage of a network and thus an LS connected to a base station provides a positioning configuration and the LS performs positioning calculation through the SL UE connected to the LS, which may correspond to case 6 in Table 1. In this case, the LS connected to the base station may provide positioning configuration information by using a positioning protocol, such as the LPP. A target UE may perform positioning measurement, based on the provided configuration information and a provided positioning signal, and may report measured positioning information to the UE connected to the LS because the target UE is within the coverage of an SL with the UE connected to the LS.

Although FIG. 5C illustrates that the UE connected to the LS is an anchor UE (i.e., an RSU), the UE may be a UE instead of the RSU. Subsequently, the measured information may be reported to the LS connected to the anchor UE (RSU), and the LS may perform positioning calculation.

FIG. 6A illustrates an operation for calculating a location of a UE through an SL according to an embodiment.

Referring to FIG. 6A, an LS provides a positioning configuration through an SL UE connected to the LS and a target UE having no connection the LS performs positioning calculation, which may correspond to case 7 in Table 1. In this case, the LS connected to the UE may provide positioning configuration information by using a positioning protocol, such as the LPP. The target UE may perform positioning calculation, based on the provided configuration information and a provided positioning signal.

FIG. 6B illustrates an operation for calculating a location of a UE through an SL according to an embodiment.

Referring to FIG. 6B, an LS provides a positioning configuration through an SL UE connected to the LS and a target UE is located within the coverage of a network and thus the LS connected to a base station performs positioning calculation, which may correspond to case 8 in Table 1. In this case, the LS connected to the UE may provide positioning configuration information by using a positioning protocol, such as the LPP. The target UE may perform positioning measurement, based on the provided configuration information and a provided positioning signal, and may report measured positioning information to the base station because the target UE is within the coverage of the base station. The reported measured information may be reported to the LS connected to the base station, and the LS may perform positioning calculation.

FIG. 6C illustrates an operation for calculating a location of a UE through an SL according to an embodiment.

Referring to FIG. 6C, an LS provides a positioning configuration through an SL UE connected to the LS and the LS performs positioning calculation through the sidelink UE connected to the LS, which may correspond to case 9 in Table 1. In this case, the LS connected to the UE may provide positioning configuration information by using a positioning protocol, such as the LPP. The target UE may perform positioning measurement, based on the provided configuration information and a provided positioning signal, and may report measured positioning information to the UE connected to the LS because the target UE is within the coverage of an SL with the UE connected to the LS.

Although FIG. 6C illustrates that the UE connected to the LS is an anchor UE (i.e., an RSU), the UE may be a UE instead of the RSU. Subsequently, the reported measured information may be reported to the LS connected to the anchor UE (RSU), and the LS may perform positioning calculation.

A positioning configuration may be performed when a request for positioning, i.e., a location service request, occurs. Table 1 illustrates that an entity performing a positioning configuration is a UE (no LS), an LS (through BS), or an LS (through UE). The LS (through UE) corresponds to a case where an LS is installed or connected to a UE, and may be referred to as a server UE. A UE which may serve as a server UE is not limited to a specific UE. For example, a target UE may be a server UE, and an anchor UE may be a server UE. Alternatively, a UE other than a target UE and an anchor UE may be a server UE. Also, the term “server UE” may be replaced by another term with a similar meaning.

An entity performing a positioning configuration may determine a target UE and an anchor UE(s) which perform SL positioning. For example, when absolute positioning is performed, an entity performing a positioning configuration may determine a plurality of anchor UEs as candidate UEs. An entity performing a positioning configuration may discover a target UE and an anchor UE(s) which perform SL positioning through a discovery procedure. A procedure by which the entity performing the positioning configuration performs discovery is not limited to a specific method. The entity performing the positioning configuration may discover the target UE and the anchor UE(s), and may trigger the UEs to transmit a positioning signal to the UEs or to report a positioning measurement result. For example, the positioning signal may be an S-PRS. According to an embodiment, UE operations are provided for triggering transmission of a positioning signal or requesting a positioning measurement result and for a UE receiving such instructions according to a positioning method supported in an SL.

The following embodiment illustrates a method of performing sidelink positioning using an S-PRS transmitted through a sidelink.

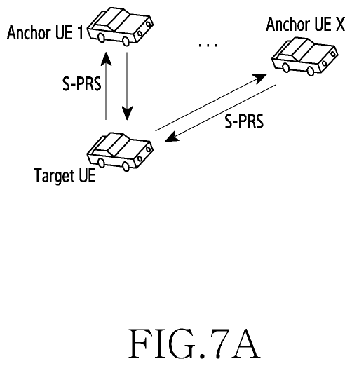

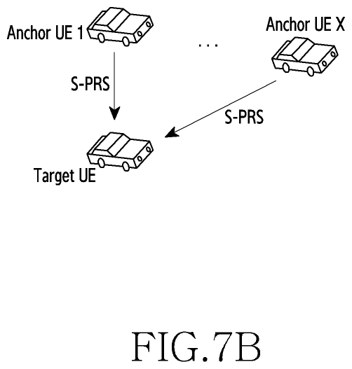

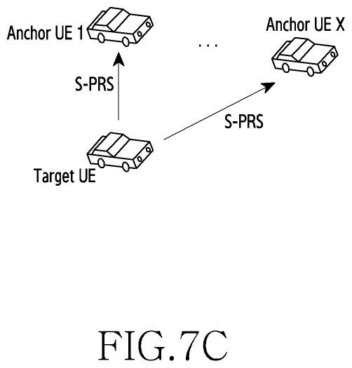

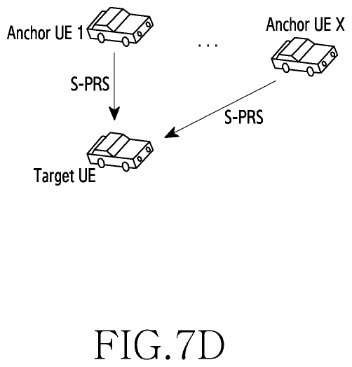

FIG. 7A illustrates sidelink round trip time (SL-RTT), sidelink reference signal time difference (SL-RSTD), sidelink relative time of arrival (SL-RTOA), and/or sidelink angle of arrival (SL-AoA) according to an embodiment of the disclosure, FIG. 7B illustrates SL-RTT, SL-RSTD, SL-RTOA, and/or SL-AoA according to an embodiment of the disclosure, FIG. 7C illustrates SL-RTT, SL-RSTD, SL-RTOA, and/or SL-AoA according to an embodiment of the disclosure, and FIG. 7D illustrates SL-RTT, SL-RSTD, SL-RTOA, and/or SL-AoA according to an embodiment of the disclosure.

However, an SL positioning method in the disclosure is not limited thereto.

More specifically, in FIGS. 7A to 7D, an entity performing a positioning configuration is not shown. As described in Table 1, the entity performing the positioning configuration may be a UE (no LS), an LS (through BS), or an LS (through UE). For example, the LS (through UE) may be referred to as a server UE, and the server UE may be a target UE, another anchor UE, or a UE other than a target UE and an anchor UE. The server UE may also be a UE and an RSU.

FIG. 7A illustrates a method of performing SL-RTT using an S-PRS transmitted through an SL, according to an embodiment.

Referring to FIG. 7A, a target UE transmits an S-PRS to a neighbor anchor UE to measure the SL-RTT of the target UE. In this case, triggering the target UE to transmit the S-PRS may be performed by the UE itself (i.e., a UE (no LS)), an LS connected to a BS (i.e., an LS (through BS)), or a server UE (i.e., an LS (through UE)). For the target UE to measure the SL-RTT, the anchor UE(s) should receive the S-PRS transmitted by the target UE and transmit an S-PRS to the target UE. Further, the anchor UE(s) should report the time difference (i.e., an Rx-Tx time difference) between when the anchor UE(s) receive the S-PRS transmitted by the target UE and when the anchor UE(s) transmits the S-PRS to the target UE. Triggering the anchor UE(s) to transmit the S-PRS to the target UE and a request to report the time difference (Rx-Tx time difference) may be performed by the UE itself (i.e., the UE (no LS)), the LS connected to the BS (i.e., the LS (through BS)), or the server UE (i.e., the LS (through UE)). According to an embodiment, triggering the anchor UE(s) to transmit the S-PRS to the target UE and the request to report the time difference (Rx-Tx time difference) may be performed by the target UE. Here, the target UE may be the server UE (i.e., the LS (through UE) or a UE not connected to the LS (i.e., the UE (no LS)).

FIG. 7B illustrates a method of performing SL-RSTD using an S-PRS transmitted through an SL according to an embodiment.

Referring to FIG. 7B, a neighbor anchor UE(s) transmits an S-PRS to a target UE to measure the SL-RSTD of the target UE. In this case, triggering the anchor UE(s) to transmit the S-PRS may be performed by the UE itself (i.e., a UE (no LS)), a LS connected to a BS (i.e., an LS (through BS)), or a server UE (i.e., an LS (through UE)). According to an embodiment, triggering the anchor UE(s) to transmit the S-PRS is performed by the target UE. In this case, the target UE may be the server UE (i.e., the LS (through UE) or a UE not connected to the LS (i.e., the UE (no LS)).

FIG. 7C illustrates a method of performing SL-RTOA using an S-PRS transmitted through an SL according to an embodiment.

Referring to FIG. 7C, for positioning of a target UE, the target UE transmits an S-PRS to a neighbor anchor UE. In this case, triggering the target UE to transmit the S-PRS may be performed by the UE itself (i.e., a UE (no LS)), an LS connected to a BS (i.e., an LS (through BS)), or a server UE (i.e., an LS (through UE)). For positioning of the target UE, the anchor UE(s) should receive the S-PRS transmitted by the target UE, measure RTOA, and report the RTOA to the target UE. A request for the anchor UE(s) to report the RTOA to the target UE may be performed by the UE itself (i.e., the UE (no LS)), the LS connected to the BS (i.e., the LS (through BS)), or the server UE (i.e., the LS (through UE)). According to an embodiment, triggering the anchor UE(s) to transmit an S-PRS to the target UE and the request to report the Rx-Tx time difference) may be performed by the target UE. Here, the target UE may be the server UE (i.e., the LS (through UE) or a UE not connected to the LS (i.e., the UE (no LS)). FIG. 7D illustrates a method of performing SL-AoA using an S-PRS transmitted through an SL according to an embodiment.

Referring to FIG. 7D, a neighbor anchor UE(s) transmits an S-PRS to a target UE to measure the SL-AoA of the target UE. In this case, triggering the anchor UE(s) to transmit the S-PRS may be performed by the UE itself (i.e., a UE (no LS)), an LS connected to a BS (i.e., an LS (through BS)), or a server UE (i.e., an LS (through UE)). The following first embodiment illustrates a case that triggering the anchor UE(s) to transmit the S-PRS is performed by the target UE. Here, the target UE may be the server UE (i.e., the LS (through UE) or a UE not connected to the LS (i.e., the UE (no LS)).

It should be noted that one or more of the following embodiments may be used in combination in the disclosure. That is, the following embodiments described in the disclosure may be mixed or combined unless contradicted with each other.

### First Embodiment

The first embodiment proposes resource information about an S-PRS and a method for configuring the same. An S-PRS may be transmitted in a resource pool where SL communication (data transmission) is performed (which may be referred to as a shared resource pool with SL communication). In another example, an S-PRS may be transmitted in a resource pool defined for S-PRS transmission (which may be referred to as a dedicated resource pool for SL positioning). For the foregoing two cases, an S-PRS resource transmission method and an S-PRS resource information configuration may vary. An S-PRS resource configuration is a higher configuration value, and a plurality of S-PRS resources may be configured.

An S-PRS resource configuration may include at least some of the following information.
S-PRS resource information 0: S-PRS resource ID
S-PRS resource information 1: Location and length of symbol in slot where S-PRS is transmitted
S-PRS resource information 2: Comb pattern information about S-PRS
S-PRS resource information 3: Frequency location where S-PRS is transmitted
S-PRS resource information 4: Information related to location in time and period at which S-PRS is transmitted
S-PRS resource information 5: S-PRS sequence ID
S-PRS resource information 6: Number of PSCCH symbols
S-PRS resource information 7: Information about whether TDM of S-PRS resources is activated in one slot and number of TDMed resources

In the disclosure, the information included in the S-PRS resource configuration is not limited to information or an information element (IE). The foregoing information or S-PRS resource configuration being configured may mean those being (pre) configured. Details about (pre) configuration are referenced in the description related to FIG. 3. For example, the S-PRS resource configuration may be preconfigured.

An S-PRS resource information 0 (S-PRS resource ID) is an identifier for distinguishing an S-PRS resource, but may not be a unique identifier depending on other S-PRS resource information configuration methods, which is referenced in the following detailed description.

How S-PRS resource information 1 to 3 may be configured according to a resource pool through which an S-PRS is transmitted is described in detail below. S-PRS resource information 4 (e.g., information related to location in time and period at which S-PRS is transmitted) may include whether S-PRS transmission through periodic reservation is used, and/or may include or configure candidate periodic reservation interval values when an S-PRS is periodically transmitted through periodic reservation. A periodic reservation interval used among the configured candidate values may be transmitted via a PSCCH through SCI. Further, S-PRS resource information 4 may include a repetition period for an S-PRS and information about a time gap between repetitions. In addition, S-PRS resource information 4 may include time off value information from a reference slot determining the start position of an S-PRS.

S-PRS resource information 5 (S-PRS sequence ID) is a 12-bit value required to generate an S-PRS sequence, and when the value is not configured, a 12-bit value corresponding to the least significant bit (LSB) of a cyclic redundancy check (CRC) used for a PSCCH connected to S-PRS transmission may be used. S-PRS resource information 6 and 7 may be configured when an S-PRS is transmitted in a resource pool defined for S-PRS transmission, which is specifically referenced herein.

First, a case in which an S-PRS is transmitted in a resource pool in which sidelink communication (data transmission) is performed is considered. Further, S-PRS resource information 1 (location and length of symbol in slot where S-PRS is transmitted) is considered. Herein, it is assumed that a slot in which an S-PRS is transmitted is determined by a slot location according to PSSCH resource allocation.

The first embodiment, the second embodiment, the third embodiment, the fourth embodiment, and the fifth embodiment can be combined with each other as long as they do not contradict each other.

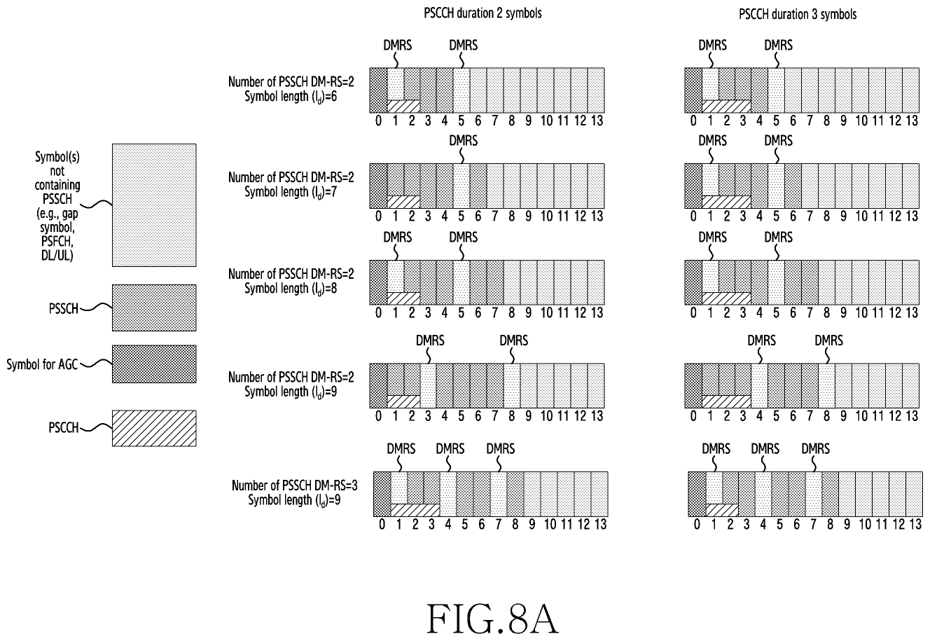

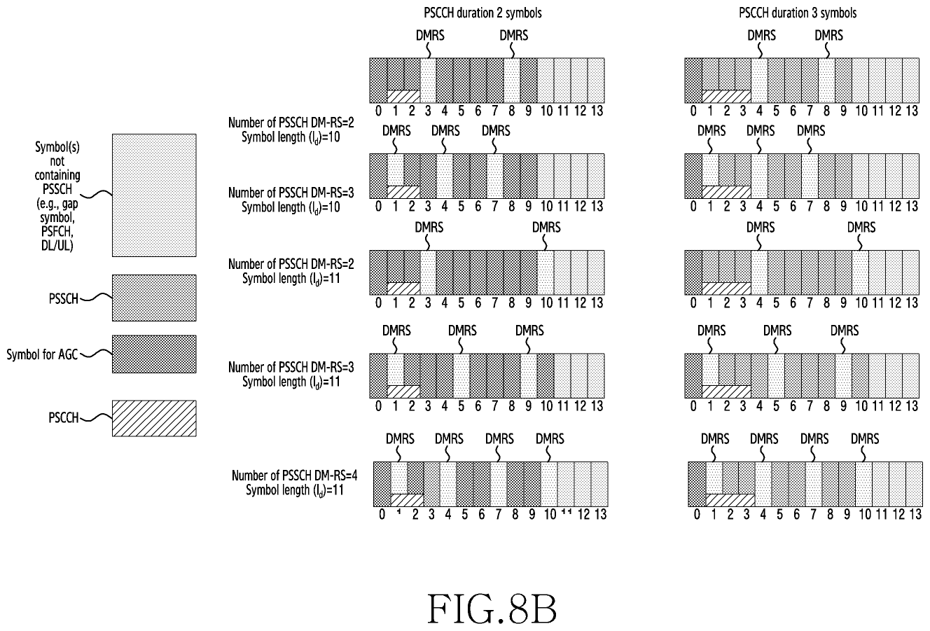

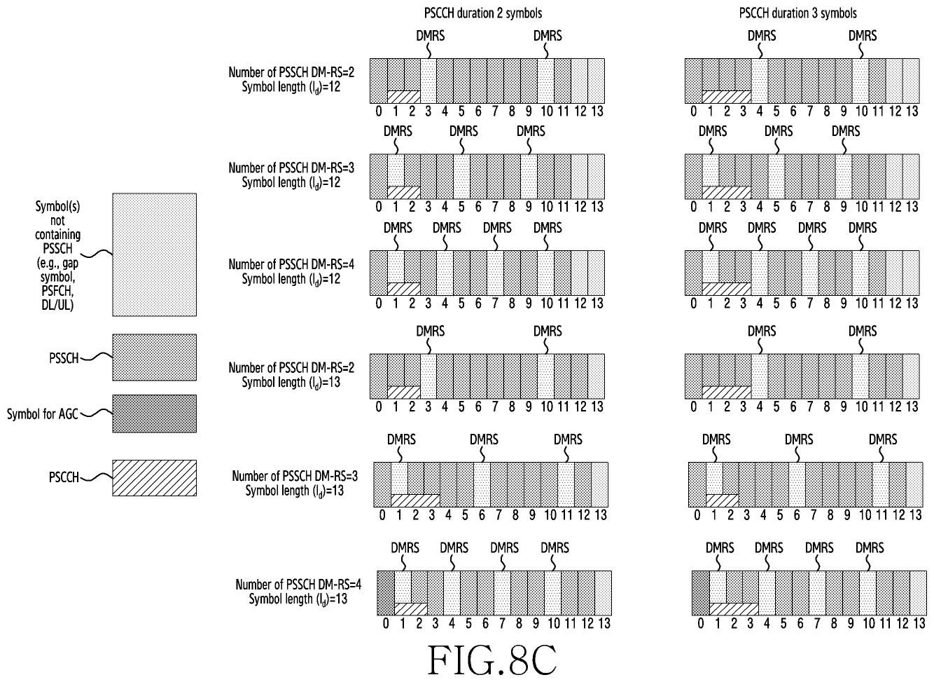

FIGS. 8A to 8C illustrate method of configuring S-PRS resource information 1, according to embodiments. That is, FIG. 8A to FIG. 8C show a possible physical layer structure in which a PSCCH/PSSCH is transmitted for sidelink communication (data transmission).

Referring to FIGS. 8A, 8B, and 8C, a PSCCH symbol length may be configured to two symbols or three symbols. The symbol length (l_{d}) of an area in which a PSCCH/PSSCH is transmitted including an automatic gain control (AGC) symbol in the first symbol may be from 6 to 13. When considering one gap symbol in the last symbol, a symbol length (sl-LengthSymbols) used for an SL operation in one slot may be configured to one value of {sym7, sym8, sym9, sym10, sym11, sym12, sym13, sym14}. The start position (sl-StartSymbol) of symbols used for the SL operation in one slot may be configured to one value of {sym0, sym1, sym2, sym3, sym4, sym5, sym6, sym7}. FIG. 8A to FIG. 8C show a case in which sl-StartSymbol=sym0.

The number of PSSCH demodulation reference signal (DMRS) symbols may be configured to from 2 to 4, and one or more numbers of PSSCH DMRS symbols may be configured. When one or more numbers of DMRS symbols are configured, a UE may determine one number of PSSCH DMRS symbols, and indicate the number of PSSCH DMRS symbols through first SCI. Here, the first SCI is transmitted through a PSCCH.

FIGS. 8A to 8C show various cases in which an SL channel and a reference signal are transmitted according to the configured PSCCH symbol length, the length (l_{d}) determined from configured sl-LengthSymbols, and the configured and determined number of DMRS symbols.

The disclosure illustrates a case in which a PSSCH and an S-PRS are transmitted by TDM in one slot when the S-PRS is transmitted in a resource pool in which sidelink communication (data transmission) is performed as in FIGS. 8A to 8C. In this case, a symbol area in which the S-PRS is transmitted should be configured. When determining and configuring the symbol area in which the S-PRS is transmitted, one or more of the following conditions may be considered.
Condition 0: The length of a symbol transmitted as an S-PRS resource may be configured to one value of {sym0, sym1, sym4}. However, in the disclosure, the length of the symbol transmitted as the S-PRS resource is not limited to {sym0, sym1, sym4}.
Condition 1: An S-PRS resource is transmitted in time-consecutive symbols.
Condition 2: An S-PRS resource is not transmitted in a symbol in which a PSSCH DMRS is transmitted.
Condition 3: An S-PRS resource is not transmitted in a symbol in which a PSCCH is transmitted.
Condition 4: An S-PRS resource is not transmitted in a symbol in which second SCI is transmitted. Although an area in which the second SCI is transmitted is not shown in FIGS. 8A to 8C, the second SCI may be mapped from a first PSSCH DMRS symbol and transmitted.
Condition 5: A symbol length of X may be allocated as an S-PRS resource from a symbol before the last PSSCH DMRS symbol. For the symbol length of X, condition 0 is referenced. For example, the symbol length may be configured to one of sym0, sym1, or sym4.

In accordance with an embodiment of the disclosure, a first method for configuring the symbol area in which the S-PRS is transmitted is a method of configuring the symbol area in which the S-PRS is transmitted within a time area configured for an SL operation (e.g., see sl-LengthSymbols and sl-StartSymbol). An S-PRS resource area may be highly limited when considering the foregoing conditions. In the first method, a symbol length (sl-LengthPRSSymbols) for transmitting the S-PRS may be configured to one value of {sym0, sym1, sym4}. The start position (e.g., sl-StartPRSSymbol) of symbols in which the S-PRS is transmitted may be configured. For example, the start position (sl-StartPRSSymbol) of the symbols in which the S-PRS is transmitted may be configured to a specific value in a slot in the time area configured for the SL operation (e.g., see sl-LengthSymbols and sl-StartSymbol), or be configured through a symbol offset value from sl-StartSymbol configured for the SL operation.

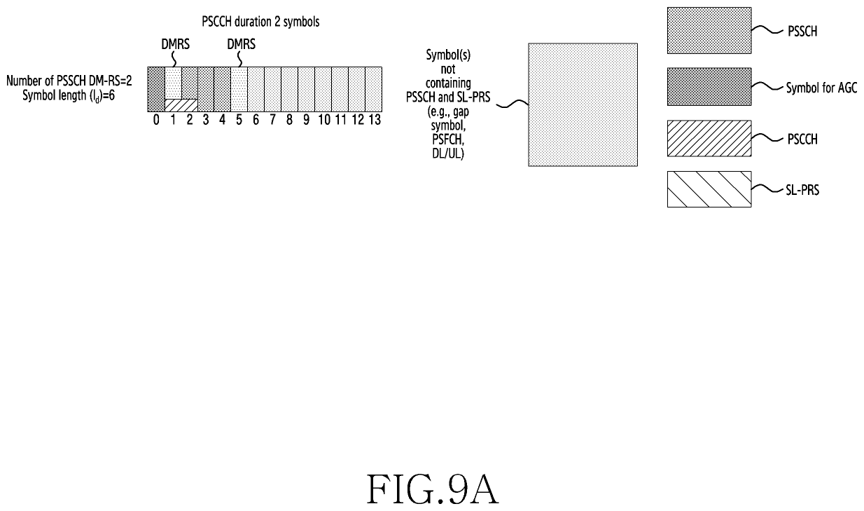

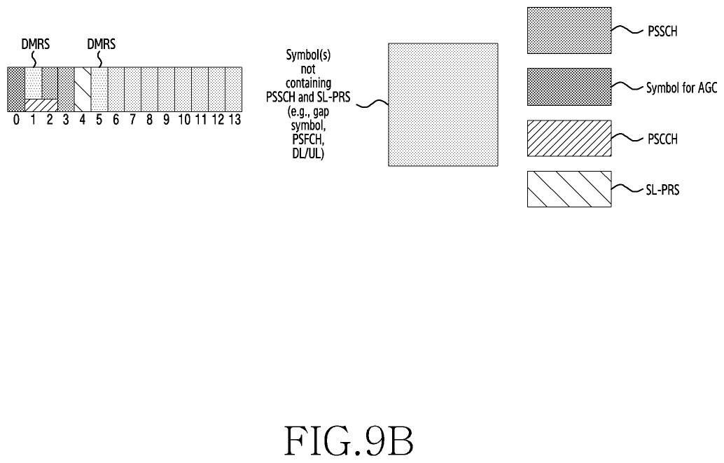

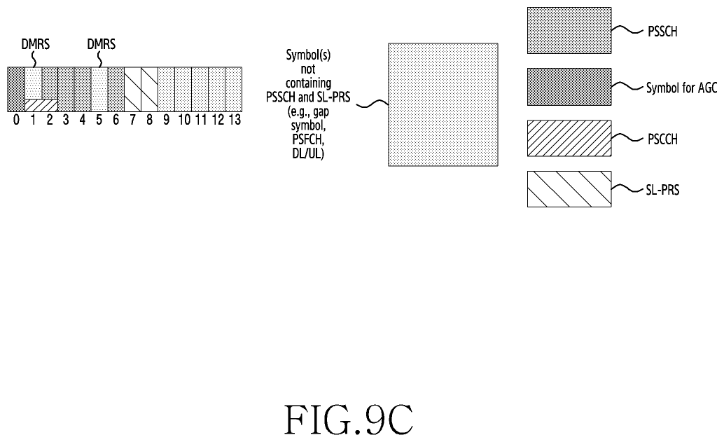

FIGS. 9A to 9C illustrate methods of determining a symbol area in which an S-PRS is transmitted within a time area configured for an SL operation, according to embodiments. More specifically, an example of the first method reference above is described with reference to FIG. 9A to FIG. 9C.

FIG. 9A corresponds to one of various cases in which an SL channel and a reference signal (e.g., an S-PRS) are transmitted in a resource area configured for an SL operation (or SL communication) as in FIGS. 8A to 8C FIG. 9B illustrates a PSSCH and/or a PSCCH that may be TDMed with an S-PRS according to the first method. FIG. 9C illustrates an symbol area other than a PSSCH and/or a PSCCH that may be TDMed with an S-PRS according to a second method.

FIG. 9B illustrates a case of applying the first method of configuring the symbol area in which the S-PRS is transmitted. For example, FIG. 9B illustrates a case of configuring an S-PRS resource to be transmitted with one symbol in a location of sym4. That is, at least one S-PRS may be transmitted by TDM with a PSSCH and/or PSCCH in one slot.

In accordance with an embodiment of the disclosure, the second method for configuring the symbol area includes a method of configuring the symbol area in which the S-PRS is transmitted outside a time area for transmitting a PSCCH/PSSCH configured for an SL operation (or SL communication) (e.g., see sl-LengthSymbols and sl-StartSymbol).

In the second method, a symbol length (sl-LengthPRSSymbols) for transmitting the S-PRS may be configured to one value of {sym0, sym1, sym4}. The start position (e.g., sl-StartPRSSymbol) of symbols in which the S-PRS is transmitted may be configured. The start position (sl-StartPRSSymbol) of the symbols in which the S-PRS is transmitted may be configured to a specific value in a slot outside the time area for transmitting the PSCCH/PSSCH configured for the SL operation (e.g., see sl-LengthSymbols and sl-StartSymbol), or be configured through a symbol offset value from sl-StartSymbol configured for the SL operation. A location in which a gap symbol is transmitted may change when the second method is used. That is, at least one S-PRS may be transmitted in a symbol area other than a symbol area corresponding to a PSSCH and/or PSCCH in one slot.

FIG. 9C illustrates a case of applying the second method of configuring the symbol area in which the S-PRS is transmitted. For example, FIG. 9C illustrates a case of configuring an S-PRS resource to be transmitted with two symbols in locations of sym7 (e.g., symbol 7) and sym8 (e.g., symbol 8).

Although the location of a gap symbol corresponds to sym6 in FIG. 9A, the location of a gap symbol may correspond to sym9, which the next symbol of the S-PRS symbol, in FIG. 9C. For reference, in FIG. 9B, the location of a gap symbol may correspond to sym6, which is the same as in FIG. 9A.

At least one S-PRS may be transmitted in symbols in various locations within a slot.

For example, at least one S-PRS may be transmitted in a symbol area (or a resource area configured for SL communication) corresponding to a PSSCH and/or PSCCH in the slot (first method). For example, at least one S-PRS may be transmitted in a symbol area excluding the symbol area corresponding to the PSSCH and PSCCH in the slot (second method).

A case in which an S-PRS is transmitted in a resource pool in which sidelink communication (data transmission) is performed is considered. Further, S-PRS resource information 2 (comb pattern information about S-PRS) is considered.

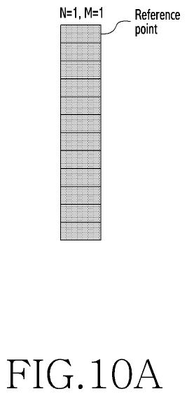

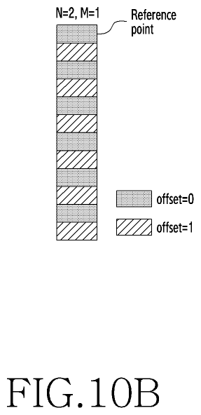

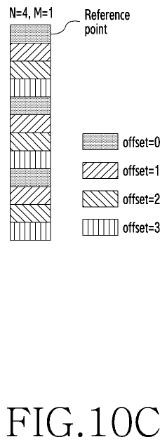

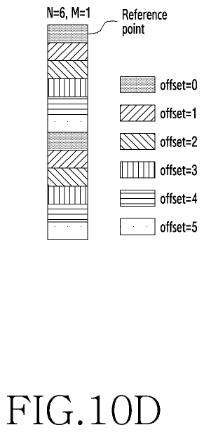

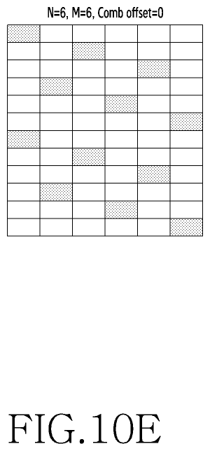

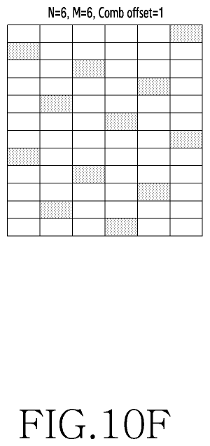

FIGS. 10A to 10F illustrate comb patterns of an S-PRS according to embodiments. A comb pattern of an S-PRS may have offset information (e.g., which may be referred to as a staggered pattern) applied to each symbol when there are one or more comb sizes (N) and symbol lengths (M) of the S-PRS.

Referring to FIGS. 10A to 10F, comb size 1 (FIG. 10A), comb size 2 (FIG. 10B), comb size 4 (FIG. 10C), and comb size 6 (FIG. 10D) available for S-PRS transmission are shown. Further, in Table 2, offset information applied to each symbol when a comb pattern is transmitted in one or more symbols is disclosed for various symbol lengths. For example, a value for the staggered pattern shown in FIGS. 10A to 10F are illustrated in Table 2.

According to Table 2, when the symbol length (M) of an S-PRS is greater than comb size (N) (M>N), the same comb offset as for first N symbols may be repeatedly applied to last (M−N) symbols. A comb size and offset information available for S-PRS transmission is not limited to those disclosed in FIGS. 10A to 10F and Table 2.

Table 2 may be a comb size and offset (staggered pattern offset) information applied to each symbol.

TABLE 2

| | Symbol index of SL positioning reference signal | | | | | | | | | | | | | |
|---|---|---|---|---|---|---|---|---|---|---|---|---|---|---|
| Comb size | 0 | 1 | 2 | 3 | 4 | 5 | 6 | 7 | 8 | 9 | 10 | 11 | 12 | 13 |
| 1 | 0 | 0 | 0 | 0 | 0 | 0 | 0 | 0 | 0 | 0 | 0 | 0 | 0 | 0 |
| 2 | 0 | 1 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 | 0 | 2 |
| 6 | 0 | 3 | 1 | 4 | 2 | 5 | 0 | 3 | 1 | 4 | 2 | 5 | 0 | 3 |
| 8 | 0 | 4 | 2 | 6 | 1 | 5 | 3 | 7 | 0 | 4 | 2 | 6 | 0 | 4 |
| 12 | 0 | 6 | 3 | 9 | 1 | 7 | 4 | 10 | 2 | 8 | 5 | 11 | 0 | 6 |

S-PRS resource information 2 may include comb offset information which may be configured differently for each UE. Final comb offset information by a staggered pattern offset and a comb offset in Table 2 may be determined by Equation (1) below.

$$Final comb offset = ( Comb offset + staggered pattern offset ) mod ( comb size ) \qquad ( 1 )$$

A detailed description of a method of determining the comb offset information in Equation (1) and signaling the comb offset information is described below.

Referring to FIGS. 10E and 10F, an example of an S-PRS pattern determined by Equation 1 is described. More specifically, FIG. 10E illustrates an example of an S-PRS pattern where N=6, M=6, and Comb offset=0 in Equation (1), and FIG. 10F illustrates an example of an S-PRS pattern where N=6, M=6, and Comb offset=1 in Equation (1). As shown in FIGS. 10E and 10F, an S-PRS may be orthogonally transmitted between UEs depending on a comb offset value.

A frequency location where an S-PRS is transmitted may be finally determined by S-PRS resource information 3 (e.g., frequency location where S-PRS is transmitted) and described S-PRS resource information 2. When an S-PRS is transmitted in a resource pool in which sidelink communication (data transmission) is performed (e.g., FIG. 9B), the number (M) of symbols and the S-PRS comb size (N) available for S-PRS transmission may be limitedly determined and configured due to a limited S-PRS transmission area as described through FIGS. 8A to 8C and FIG. 9. For example, the number (M) of symbols and the S-PRS comb size (N) may be configured to values of M≤4 and N≤4, respectively.

A case in which an S-PRS is transmitted in a resource pool in which sidelink communication (data transmission) is performed is described below. Further, S-PRS resource information 3 (frequency location where S-PRS is transmitted) is also described. Herein, the frequency location where the S-PRS is transmitted is determined by the frequency location of a PSSCH. The frequency location of the PSSCH may be determined by a PSSCH frequency location configuration and PSSCH resource selection and allocation. Details of the PSSCH resource selection and allocation are described in the following second embodiment. The PSSCH frequency location configuration used for an SL operation may include a subchannel size, a subchannel start position, and the number of subchannels. The subchannel size (sl-SubchannelSize) may be configured to one value of {n10, n12, n15, n20, n25, n50, n75, n100}. The PSSCH subchannel start position (sl-StartRB-Subchannel) may be configured to one value of {0, . . . , 265}. The number of subchannels (sl-NumSubchannel) of the PSSCH may be configured to one value of {1, . . . , 27}.

A case in which an S-PRS is transmitted in a resource pool defined for S-PRS transmission is described. Further, S-PRS resource information 1 (location and length of symbol in slot where S-PRS is transmitted) is described.

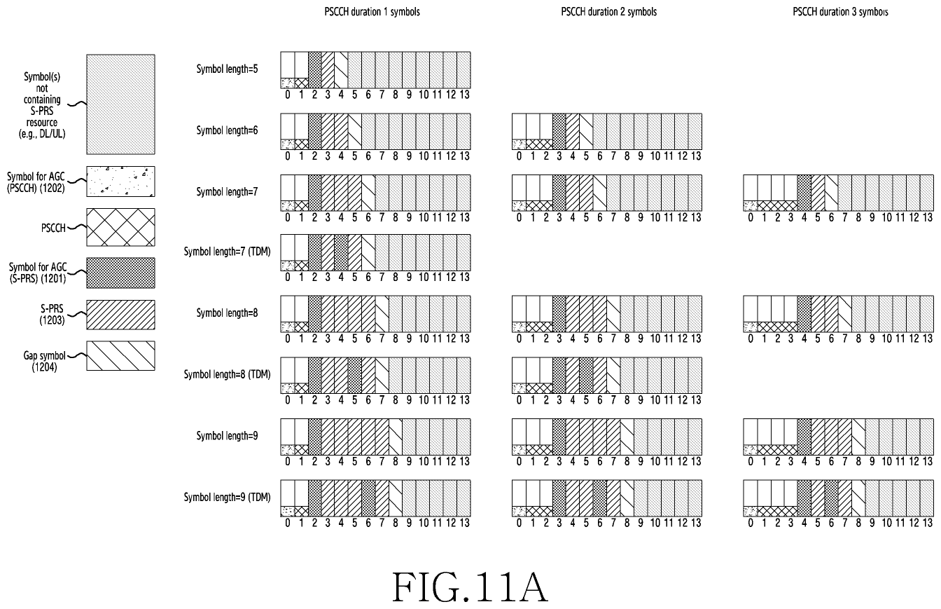

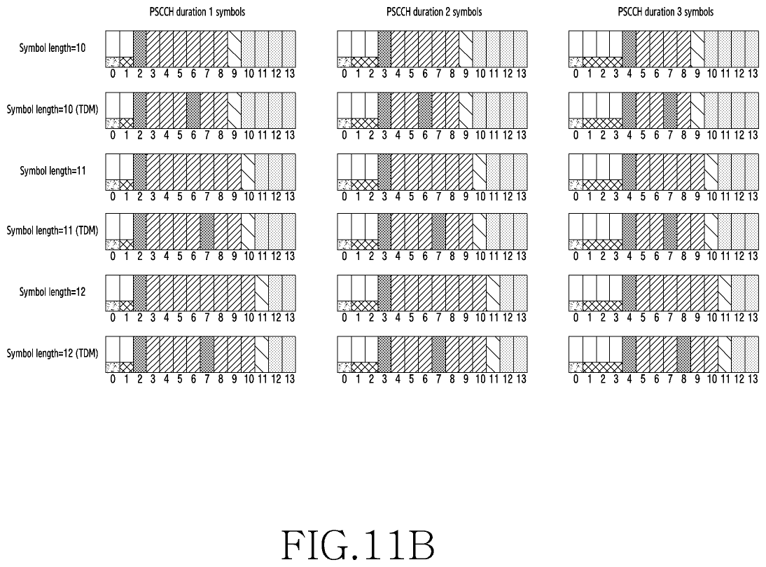

FIGS. 11A and 11B illustrate methods of configuring S-PRS resource information 1 according to embodiments. More specifically, FIGS. 11A and 11B show a possible physical layer structure in which an S-PRS is transmitted.

Referring to FIGS. 11A and 11B, a PSCCH symbol length (i.e., S-PRS resource information 6) may be configured to one symbol, two symbols, or three symbols. In another example, the PSCCH symbol length may be configured to two symbols or three symbols. The first symbol may be transmitted as an AGC symbol for a PSCCH. An AGC symbol for an S-PRS may be transmitted before a symbol in which the S-PRS is transmitted. One gap symbol may be transmitted as the last symbol. When the PSCCH symbol length is configured to two symbols or three symbols, a symbol length (sl-LengthPRSSymbols) used for S-PRS transmission in one slot may be configured to one value of {sym6, sym7, sym8, sym9, sym10, sym11, sym12, sym13, sym14}. When considering that the PSCCH symbol length is configured to one symbol, two symbols, or three symbols, the symbol length (sl-LengthPRSSymbols) used for S-PRS transmission in one slot may be configured to one value of {sym5, sym6, sym7, sym8, sym9, sym10, sym11, sym12, sym13, sym14}.

Further, when the PSCCH symbol length is configured to two symbols or three symbols, the start position (sl-StartPRSSymbol) of a symbol used for an SL operation (or SL communication) in one slot may be configured to one value of {sym0, sym1, sym2, sym3, sym4, sym5, sym6, sym7, sym8}. When the PSCCH symbol length is configured to one symbol, two symbols, or three symbols, the start position (sl-StartPRSSymbol) of the symbol used for the SL operation (or SL communication) in one slot may be configured to one value of {sym0, sym1, sym2, sym3, sym4, sym5, sym6, sym7, sym8, sym9}. FIGS. 11A and 11B illustrate a case of configuring sl-StartPRSSymbol=sym0.

FIGS. 11A and 11B show a case in which S-PRS resources are TDMed within a slot.

Although FIGS. 11A and 11B show a case in which the maximum number of TDMed S-PRS resources is 2, the number of TDMed S-PRS resources is not limited to a maximum of 2 in the disclosure. For example, the number of TDMed S-PRS resources may be up to X, and X may be, for example, 2 or 3. When X=2, the number of symbols of a first TDMed S-PRS resource may be assumed to be equal to or greater than the number of symbols of a first TDMed S-PRS resource. Alternatively, the number of symbols of a first TDMed S-PRS resource may be assumed to be less than or equal to the number of symbols of a first TDMed S-PRS resource. When using these assumptions, it is not necessary to separately indicate the locations and the number of symbols of TDMed S-PRS resources may not need to be separately indicated.

In FIGS. 11A and 11B, an AGC symbol 1201 is transmitted in a symbol before an S-PRS resource. The AGC symbol 1201 may be distinguished from an AGC symbol 1202 for a PSCCH. The AGC symbol 1201 may be generated by duplicating an S-PRS symbol 1203 following the AGC symbol. The AGC symbol 1201 may be transmitted in the first symbol of the S-PRS resource in each S-PRS resource. Therefore, when S-PRS resources are TDMed within a slot, the AGC symbol 1201 may be transmitted in a symbol preceding each TDMed S-PRS resource. Further, a gap symbol 1204 may be transmitted as the last symbol of the S-PRS resource.

When S-PRS resources are TDMed within a slot and when a UE performs Tx-Rx switching between the TDMed S-PRS resources, although not illustrated in FIGS. 11A and 11B, the gap symbol 1402 may be additionally transmitted between the TDMed S-PRS resources. However, since the UE may perform Tx-Rx switching within the period of the AGC symbol 1201, the gap symbol 1204 is not considered between the TDMed S-PRS resources in FIG. 11A and FIG. 11B.

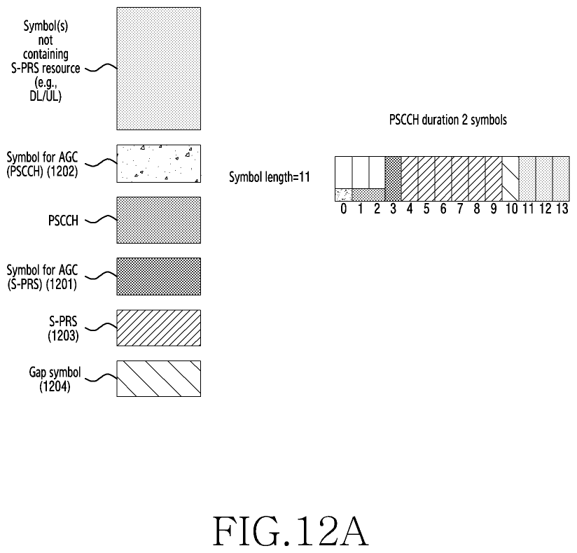

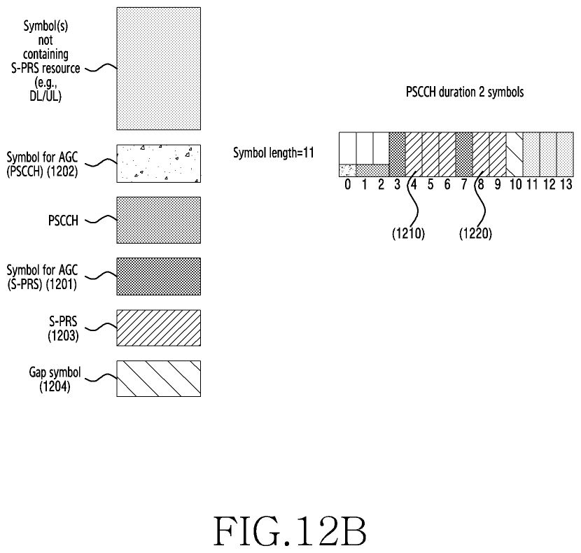

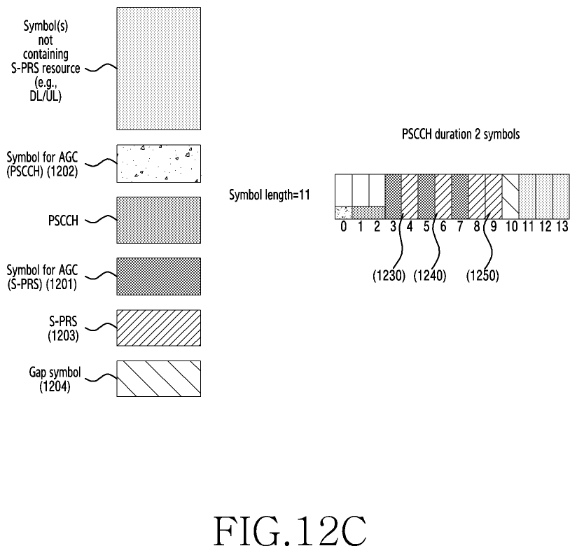

FIGS. 12A to 12C illustrates a case in which S-PRS resources are TDMed within a slot in a method of configuring S-PRS resource information 1, according to embodiments.

Referring to FIGS. 12A to 12C, a case in which S-PRS resources are TDMed within a slot may be configured only when multiplexing different UEs without applying to the same UE. For example, information about whether TDM of S-PRS resources is activated and the number of TDMed resources may be configured based on S-PRS resource information 7 (e.g., information about whether TDM of S-PRS resources is activated in one slot and number of TDM resources).

FIG. 12A illustrates a case in which S-PRS resources are not TDMed when a symbol length used for S-PRS transmission is 11 and a PSCCH symbol length is two symbols.

FIG. 12B illustrates a case in which two S-PRS resources are TDMed when a symbol length used for S-PRS transmission is 11 and a PSCCH symbol length is two symbols. As illustrated in FIG. 12B, when two S-PRS resources are TDMed, whether an S-PRS is transmitted in a first resource area 1210 or in a second resource area 1220 may need to be determined and indicated through a resource allocation result for the S-PRS (see the second embodiment for details). As shown below in Table 9 of a fifth embodiment, a method of indicating a TDM offset value via SCI may be considered. Alternatively, a method of associating the frequency location of a PSCCH and a TDMed S-PRS resource area without additional signaling may be considered. For example, when considering that a frequency location where a PSCCH is transmitted may be different for each UE and there are X possible frequency locations where the PSCCH is transmitted, a TDMed S-PRS resource area may be determined depending on a location where the PSCCH is transmitted among the X locations.

FIG. 12C illustrates a case in which three S-PRS resources are TDMed when a symbol length used for S-PRS transmission is 11 and a PSCCH symbol length is two symbols.

As illustrated in FIG. 12C, when three S-PRS resources are TDMed, whether an S-PRS is transmitted in a first resource area 1230, in a second resource area 1240, or in a third resource area 1250 may need to be determined and indicated through a resource allocation result for the S-PRS (see the second embodiment for details). As shown below in Table 9 of the fifth embodiment, a method of indicating a TDM offset value via SCI may be considered. Alternatively, a method of associating the frequency location of a PSCCH and a TDMed S-PRS resource area without additional signaling may be considered. For example, when considering that a frequency location where a PSCCH is transmitted may be different for each UE and there are X possible frequency locations where the PSCCH is transmitted, a TDMed S-PRS resource area may be determined or identified depending on a location where the PSCCH is transmitted among the X locations.

A case in which an S-PRS is transmitted in a resource pool defined for S-PRS transmission is described below. S-PRS resource information 2 (e.g. Comb pattern information about S-PRS) is described, a detailed description of which is made in FIGS. 10A to 10F. When an S-PRS is transmitted in a resource pool defined for S-PRS transmission, a wider S-PRS transmission area may be secured. Therefore, when the S-PRS is transmitted in the resource pool defined for S-PRS transmission, the number (M) of symbols and S-PRS comb size (N) available for S-PRS transmission may be configured to greater values than those when an S-PRS is transmitted in a resource pool in which SL communication (e.g., data transmission) is performed (e.g., FIG. 9B). Further, a frequency location in which the S-PRS is transmitted may be determined through a resource allocation result for the S-PRS (see the second embodiment for details), and a corresponding comb offset may be indicated. In this case, as shown below in Table 9 of the fifth embodiment, a method of indicating a comb offset value via SCI may be considered.

Alternatively, a method of associating the frequency location of a PSCCH and a comb offset without additional signaling may be considered. For example, when considering that a frequency location where a PSCCH is transmitted may be different for each UE and there are X possible frequency locations where the PSCCH is transmitted, a comb offset may be determined depending on a location where the PSCCH is transmitted among the X locations, thus determining the frequency location in which the S-PRS is transmitted.

In addition, a method of associating the frequency location of a PSCCH, a comb offset, and a TDM offset together may be considered. When considering that a frequency location where a PSCCH is transmitted may be different for each UE and there are X possible frequency locations where the PSCCH is transmitted, a comb offset and a TDM offset may be determined depending on a location where the PSCCH is transmitted among the X locations, thus determining or identifying time and frequency locations in which the S-PRS is transmitted.

A case in which an S-PRS is transmitted in a resource pool defined for S-PRS transmission is described below. More specifically, S-PRS resource information 3 (frequency location where S-PRS is transmitted) is described.

When an S-PRS is transmitted in a resource pool defined for S-PRS transmission, a frequency location in which the S-PRS is transmitted may be determined by a frequency location configuration of the S-PRS. For example, the frequency location configuration of the S-PRS may be determined based on the start position of the S-PRS in frequency and the number of RBs thereof. When the S-PRS is transmitted in the resource pool defined for S-PRS transmission, the S-PRS may be transmitted in the entire area of a configured frequency location, which may mean that an additional UE operation for allocating a frequency resource is not defined. That is, resource selection for S-PRS may be performed only for a time location in which the S-PRS is transmitted. Further, the configured frequency location may be applied equally to all UEs using the resource pool. However, the location of a resource element (RE) in which S-PRS is transmitted may vary for each UE depending on a S-PRS comb pattern. Therefore, an S-PRS resource ID included in an S-PRS resource configuration may be a unique identifier for distinguishing an S-PRS resource. When an S-PRS is transmitted in a resource pool in which sidelink communication (data transmission) is performed, S-PRS resource information 3 (e.g., frequency location where S-PRS is transmitted) may vary for each UE depending on a resource selection result, and thus an S-PRS resource ID included in an S-PRS resource configuration may not be a unique identifier for distinguishing an S-PRS resource. In this case, the S-PRS resource may be uniquely determined or identified for each UE depending on the S-PRS resource ID and selected S-PRS resource information 3 (frequency location where S-PRS is transmitted).

### Second Embodiment

The second embodiment proposes a resource selection method in S-PRS transmission. Resource selection for S-PRS transmission in SL positioning may include a method in which a base station allocates a resource for S-PRS transmission (hereinafter, referred to as scheme 1 or mode 1) and a method in which a UE directly selects a resource through sensing (hereinafter, referred to as scheme 2 or mode 2). In scheme 2, a UE operation should be defined. An S-PRS may be transmitted in a resource pool where sidelink communication (data transmission) is performed (which may be referred to as a shared resource pool with SL communication). In another example, an S-PRS may be transmitted in a resource pool defined for S-PRS transmission (which may be referred to as a dedicated resource pool for SL positioning). For the foregoing two cases, the operation of scheme 2 may change.

First, a case in which an S-PRS is transmitted in a resource pool in which sidelink communication (data transmission) is performed is described.

In this case, scheme 2 may be determined according to (or based on) a method in which a UE directly selects a resource through sensing for PSSCH transmission (hereinafter, referred to as mode 2). That is, the S-PRS may be transmitted by TDM within a slot based on time (slot) and frequency resource locations selected for PSSCH transmission as shown in FIGS. 9A to 9C. However, when the S-PRS is transmitted in the resource pool in which SL communication (data transmission) is performed, there may be the following modifications in the procedure of mode 2. However, the following modifications are only examples in the disclosure, and the disclosure is not limited to the following modifications.
Modification 1-1: An L1 priority value may be determined as a higher priority value by comparing the priority of SL communication (e.g. data transmission) and the priority for the S-PRS. Priority may be an integer value ranging from 1 to 8, and may be a value determined by a logical channel prioritization procedure. For example, a priority value of 1 may indicate the highest priority, and a priority value of 8 may indicate the lowest priority. That is, a priority with a higher value may be may be referenced with a higher priority, which is only for illustration, and a priority with a lower value may have a higher priority. In modification 1-1, a case in which the priority of the S-PRS is fixed to 1 may also be considered. In this case, the L1 priority value is always fixed to 1.

The priority of the SL communication (data transmission) and the priority of the S-PRS may be different. A UE may determine a higher priority value as the L1 priority value by comparing the priority of the SL communication for data transmission and the priority of the S-PRS, and may perform mode-2 sensing. A priority value that the UE includes in first SCI and indicates to another UE may also be the L1 priority value determined by comparing the priority of the SL communication for data transmission and the priority of the S-PRS.
Modification 1-2: An S-PRS comb size (N) may be configured to a fixed specific value. When one or more values of N are configured, a UE may select an S-PRS comb size, and may indicate the value to another UE through second SCI.
Modification 1-3: When a S-PRS comb size (N) is greater than 1, a comb offset value may be fixed to a specific value, or be randomly selected. The selected comb offset value may be indicated to another UE through second SCI.

When the method presented in modification 1-1 is not used, the L1 priority value may be determined as the priority of the SL communication (data transmission). The L1 priority value may be determined as the priority value of the S-PRS or be assumed as a specific priority value when there is no data for SL communication, but the SL-PRS is transmitted. For example, the specific priority value may be assumed as corresponding to a priority value of 1. In modification 1-2 and modification 1-3, the S-PRS comb size (N) and the comb offset value may be included in DCI and indicated to the UE even in an operation according to scheme 1.

A case in which an S-PRS is transmitted in a resource pool defined for S-PRS transmission is described below.

In this case, in scheme 2, a UE may directly determine a transmission resource through sensing for an S-PRS resource. When the S-PRS is transmitted in the resource pool defined for S-PRS transmission, the S-PRS may be interpreted as being transmitted in the entire configured frequency location area. Therefore, resource selection for the S-PRS may be performed only for a time location in which the S-PRS is transmitted. When the S-PRS is transmitted in the resource pool defined for S-PRS transmission, there may be the following modifications in the procedure of mode 2. However, modifications according to the disclosure are not limited to the following modifications.
Modification 2-1: Unlike mode 2 in which a PSCCH DMRS or PSSCH DMRS is used to calculate L1-RSRP, an SL-PRS is used to calculate L1-RSRP.
Modification 2-2: An L1 priority value is determined as the priority value of an S-PRS. Priority may be an integer value ranging from 1 to 8, and may be a value determined by a logical channel prioritization procedure. For example, a priority value of 1 may indicate the highest priority, and a priority value of 8 may indicate the lowest priority. A priority value may be indicated or transmitted to another UE through SCI.
Modification 2-3: An S-PRS comb size (N) may be configured to a fixed specific value. When one or more values of N are configured, a UE may select an S-PRS comb size, and may indicate the value to another UE through SCI.
Modification 2-4: When a S-PRS comb size (N) is greater than 1, a comb offset value may be fixed to a specific value, or be randomly selected. The selected comb offset value may be indicated or transmitted to another UE through SCI.

In modification 2-3 and modification 2-4, the S-PRS comb size (N) and the comb offset value may be included in DCI and indicated or transmitted to the UE even in an operation according to scheme 1.

The first embodiment, the second embodiment, the third embodiment, the fourth embodiment, and the fifth embodiment can be combined with each other as long as they do not contradict each other.

### Third Embodiment

A third embodiment illustrates information that may be included in first SCI when an S-PRS is transmitted in a resource pool where SL communication (data transmission) is performed (which may be referred to as a shared resource pool with SL communication) is provided.

When an S-PRS is transmitted in a resource pool where SL communication (data transmission) is performed, a UE transmitting an S-PRS and an existing UE not transmitting an S-PRS may coexist. Thus, to successfully decode and receive data and an S-PRS, UEs in the resource pool need to indicate whether the S-PRS is included in current SL transmission, which may be a method for ensuring backward compatibility between the existing UE and the UE transmitting the S-PRS.

As a first method for indicating whether an S-PRS is included in current SL transmission, a method of explicitly indicating whether an S-PRS is included in current SL transmission through a PSCCH (first SCI) is provided. For example, an example using a reserved bit in the first SCI is shown below in Table 3. In the disclosure, a method of indicating whether an S-PRS is transmitted through a PSCCH (first SCI) is not limited to a method shown below in Table 3.

TABLE 3
Reserved - a number of bits as determined by the following:

| - | N reserved bits as configured by higher layer parameter sl-NumReservedBits, | |
|---|---|---|
| | with value set to zero, if higher layer parameter sl-IndicationUE-B is not | |
| | configured, or if higher layer parameter sl-IndicationUE-B is configured to | |
| | ′disabled′, and if SL-PRS is not configured by higher layer; | |
| | - | (N_reserved-1) bits [symbol] , with value set to zero if higher layer |
| | | parameter sl-IndicationUE-B is configured to ‘enabled’ or if SL-PRS is |
| | | configured by higher layer;.̅ |
| | - | (N_reserved-2) bits, with value set to zero, if higher layer parameter sl- |
| | | NumReservedBits>2, and if higher layer parameter sl-IndicationUE-B is |
| | | configured to ‘enabled’, and if SL-PRS is configured by higher layer |
| | - | No reserved bit if higher layer parameter sl-NumReservedBits=2, and if |
| | | higher layer parameter sl-IndicationUE-B is configured to ‘enabled’, and |
| | | if SL-PRS is configured by higher layer |

Conflict information receiver flag - 0 or 1 bit

| - | 1 bit if higher layer parameter sl-IndicationUE-B is configured to ′enabled′, where | |
|---|---|---|
| | the bit value of 0 indicates that the UE cannot be a UE to receive conflict | |
| | information and the bit value of 1 indicates that the UE can be a UE to receive | |
| | conflict information as defined in Clause 16.3.0 of [5, TS 38.213]; | |
| | - | 0 bit otherwise. |

SL-PRS presence flag - 0 or 1 bit

| | |
|---|---|
| - | 1 bit if SL-PRS is configured by higher layer and UE transmits SL-PRS, |
| - | 0 bit otherwise. |

Table 3 illustrates a method of indicating whether an S-PRS is transmitted by using a reserved bit when indicating whether the S-PRS is transmitted with one-bit information through a PSCCH (first SCI). When the S-PRS is transmitted in a resource pool where sidelink communication (data transmission) is performed, as described in the first embodiment, a related parameter (e.g., an S-PRS parameter) being configured through an S-PRS resource configuration with a higher-layer parameter (e.g., an RRC parameter) may be interpreted as activation of S-PRS transmission. Alternatively, whether S-PRS transmission is activated may be explicitly configured (in case that SL-PRS is configured by higher layer). That is, whether S-PRS transmission is activated may be implicitly indicated through the higher-layer parameter, or be explicitly indicated through the reserved bit.

In this case, as shown in Table 3, 1 bit of the reserved bit may be used to indicate whether a UE transmits an S-PRS. However, referring to Table 3, the reserved bit may be already used to indicate “Conflict information receiver flag”. Therefore, as in Table 3, the reserved bit may be differently used and configured based on information about the number of bits configured as reserved bits (e.g., sl-NumReservedBits) and/or information about whether the conflict information receiver flag is also used (e.g., sl-IndicationUE-B).

As a second method for indicating whether an S-PRS is included in current SL transmission, a method of implicitly indicating whether an S-PRS is included in current SL transmission through a PSCCH (first SCI) is provided. For example, an example using a 2nd-stage SCI format field in the first SCI is illustrated below in Table 4. A case in which the 2nd-stage SCI format field is indicated as “11” and thus SCI format 2-D is used may be interpreted as an S-PRS being included in transmission.

TABLE 4

| Value of 2nd-stage SCI format field | 2nd-stage SCI format |
|---|---|
| 00 | SCI format 2-A |
| 01 | SCI format 2-B |
| 10 | SCI format 2-C |
| 11 | SCI format 2-D |

### Fourth Embodiment

A fourth embodiment illustrates information that may be included in second SCI when an S-PRS is transmitted in a resource pool where sidelink communication (data transmission) is performed (which may be referred to as a shared resource pool with SL communication) is provided.

A first method of indicating SCI format 2-D through a 2nd-stage SCI format field in a PSCCH (first SCI) is described (see Table 4). For example, an example of control information that may be included in SCI format 2-D is described below with reference to Table 5. As described in Table 5, some control information may not be included. The disclosure is not limited to the control information included in Table 5.

Table 5 may be considered as adding at least some of the following information to control information included existing SCI format 2-C. For example, the control information may include at least some of fields or information included in Table 5.
Cast type indicator: SCI format 2-C is supported only in unicast and thus does not need a cast type indicator. However, since S-PRS transmission is supported in all cast types, a cast type indicator field may be indicated.
IUC enable/disable indicator: Inter-UE coordination (IUC) information may be used for S-PRS transmission, but there may be UEs not supporting IUC, and thus IUC may be activated and deactivated through an IUC enable/disable indicator field. When IUC is deactivated, an IUC providing/requesting indicator and IUC providing/requesting information may not be used.
S-PRS request: May be used to request an S-PRS from another UE.
S-PRS measurement report request: May be used to request a result measured with an S-PRS from another UE.
S-PRS comb pattern: May be used to indicate a selected comb pattern (see a related description in FIGS. 10A to 10F).
S-PRS comb offset: May be used to indicate a selected comb offset (see a related description in FIGS. 10A to 10F).
SL-PRS symbol number: May be used to indicate a selected symbol number.

TABLE 5

| Field | Bits | Comments |
|---|---|---|
| HARQ process ID | 4 | These fields are common in SCI format 2- |
| New data indicator | 1 | A/B/C |
| Redundancy version | 2 | Source ID and destination ID can be shared |
| Source ID | 8 | with SL-SCH |
| Destination ID | 16 | |
| HARQ feedback | 1 | |
| enable/disable indicator | | |
| Cast type indicator | 2 | From SCI format 2-A |
| CSI request | 1 | From SCI format 2-A and 2-C |
| | | This information is not essential and can be |
| | | removed. |
| IUC enable/disable indicator | 1 | New |
| IUC providing/requesting | 1 | From SCI format 2-C |
| indicator | | |
| IUC providing/requesting | X | From SCI format 2-C. |
| information | | See details about IUC providing and |
| | | requesting information in SCI format 2-C |
| | | X depends on IUC providing or requesting |
| | | information |
| S-PRS request | 1 | New |
| S-PRS measurement report | 1 | This information can be removed. |
| request | | |
| S-PRS comb pattern | ┌log₂ P┐ | New |
| | | P is the number of comb patterns |
| | | configured by higher layer parameter sl- |
| | | PRS-CombPatternList. |
| | | One comb pattern can be decided by higher |
| | | layer and this information can be removed. |
| S-PRS comb offset | ┌log₂ N┐ | New |
| | | N is the S-PRS comb size. |
| | | Higher layer can provide this information |
| | | and this information can be removed. |
| SL-PRS symbol number | ┌log₂ S┐ | New |
| | | S is the number of SL-PRS symbols |
| | | configured by higher layer parameter sl- |
| | | PRS-symLengthList. |
| | | Higher layer can provide this information |
| | | and this information can be removed. |
| Padding bits | | To make a single SCI format 2-D |

A second method in which a 2nd-stage SCI format field in a PSCCH (first SCI) is not used to indicate SCI format 2-D is described. In the second method, as shown in Table 3 in the third embodiment, a method of indicating whether an S-PRS is included by using a reserved bit in the PSCCH (first SCI) is described. SCI format 2-D may be configured using SCI format 2-A/B/C indicated by the 2nd-stage SCI format field in the PSCCH (1st SCI). In the method, any existing SCI format 2-A/B/C may be used compared to the first method corresponding to Table 5. Further, that reserved bit in the 2nd-stage SCI format field may still be saved. For example, SCI format 2-D may include the following three types.
SCI format 2-D type 1: SCI format 2-A+S-PRS specific information (see Table 6)
SCI format 2-D type 2: SCI format 2-B+S-PRS specific information (see Table 7)
SCI format 2-D type 3: SCI format 2-C+S-PRS specific information (see Table 8)

S-PRS specific information may refer to an S-PRS request, an S-PRS measurement report request, an S-PRS comb pattern, an S-PRS comb offset, and/or an SL-PRS symbol number in Tables 6 to 8. As described in Tables 6 to 8, some control information may not be included. Additionally, control information is not limited to control information included below in Table 6 to Table 8.

Table 6 may be SCI format 2-D type 1 (SCI format 2-A+SL-PRS specific information). For example, the control information may include at least some of fields or information included in Table 6, Table 7, or Table 8. That is, the control information may include only some or all of the fields or information included in Table 6, Table 7, or Table 8.

TABLE 6

| Field | Bits | Comments |
|---|---|---|
| HARQ process ID | 4 | From SCI format 2-A |
| New data indicator | 1 | |
| Redundancy version | 2 | |
| Source ID | 8 | |
| Destination ID | 16 | |
| HARQ feedback | 1 | |
| enable/disable indicator | | |
| Cast type indicator | 2 | |
| CSI request | 1 | |
| S-PRS request | 1 | New |
| S-PRS measurement report | 1 | This information can be removed. |
| request | | |
| S-PRS comb pattern | ┌log₂ P┐ | New |
| | | P is the number of comb patterns configured |
| | | by higher layer parameter sl-PRS- |
| | | CombPatternList. |
| | | One comb pattern can be decided by higher |
| | | layer and this information can be removed. |
| S-PRS comb offset | ┌log₂ N┐ | New |
| | | N is the S-PRS comb size. |
| | | Higher layer can provide this information and |
| | | this information can be removed. |
| S-PRS symbol number | ┌log₂ S┐ | New |
| | | S is the number of SL-PRS symbols |
| | | configured by higher layer parameter sl-PRS- |
| | | symLengthList. |
| | | Higher layer can provide this information and |
| | | this information can be removed. |
| Padding bits | | To make a single SCI format 2-D |

Table 7 may be SCI format 2-D type 2 (SCI format 2-B+SL-PRS specific information). The control information may include at least some of information or fields included in Table 7. For example, the control information may include only some or all of the information or fields included in Table 7.

TABLE 7

| Field | Bits | Comments |
|---|---|---|
| HARQ process ID | 4 | From SCI format 2-B |
| New data indicator | 1 | |
| Redundancy version | 2 | |
| Source ID | 8 | |
| Destination ID | 16 | |
| HARQ feedback | 1 | |
| enable/disable indicator | | |
| Zone ID | 12 | |
| Communication range | 4 | |
| requirement | | |
| S-PRS request | 1 | New |
| S-PRS measurement | 1 | This information can be removed. |
| report request | | |
| S-PRS comb pattern | ┌log₂ P┐ | New |
| | | P is the number of comb patterns configured by |
| | | higher layer parameter sl-PRS-CombPatternList. |
| | | One comb pattern can be decided by higher layer |
| | | and this information can be removed. |
| S-PRS comb offset | ┌log₂ N┐ | New |
| | | N is the S-PRS comb size. |
| | | Higher layer can provide this information and this |
| | | information can be removed. |
| S-PRS symbol number | ┌log₂ S┐ | New |
| | | S is the number of SL-PRS symbols configured by |
| | | higher layer parameter sl-PRS-symLengthList. |
| | | Higher layer can provide this information and this |
| | | information can be removed. |
| Padding bits | | To make a single SCI format 2-D |

Table 8 may be SCI format 2-D type 3 (SCI format 2-C+SL-PRS specific information). The control information may include at least some of information or fields included in Table 8. For example, the control information may include only some or all of the information or fields included in Table 8.

TABLE 8

| Field | Bits | Comments |
|---|---|---|
| HARQ process ID | 4 | From SCI format 2-C |
| New data indicator | 1 | See details about IUC providing and |
| Redundancy version | 2 | requesting information in SCI format 2-C |
| Source ID | 8 | X depends on IUC providing or requesting |
| Destination ID | 16 | information |
| HARQ feedback enable/disable | 1 | |
| indicator | | |
| CSI request | 1 | |
| IUC Providing/Requesting | 1 | |
| indicator | | |
| IUC providing/requesting | X | |
| information | | |
| S-PRS request | 1 | New |
| S-PRS measurement report | 1 | This information can be removed. |
| request | | |
| S-PRS comb pattern | ┌log₂ P┐ | New |
| | | P is the number of comb patterns |
| | | configured by higher layer parameter sl- |
| | | PRS-CombPatternList. |
| | | One comb pattern can be decided by higher |
| | | layer and this information can be removed. |
| S-PRS comb offset | ┌log₂ N┐ | New |
| | | N is the S-PRS comb size. |
| | | Higher layer can provide this information |
| | | and this information can be removed. |
| S-PRS symbol number | ┌log₂ S┐ | New |
| | | S is the number of SL-PRS symbols |
| | | configured by higher layer parameter sl- |
| | | PRS-symLengthList. |
| | | Higher layer can provide this information |
| | | and this information can be removed. |
| Padding bits | | To make a single SCI format 2-D |

### Fifth Embodiment

A fifth embodiment, illustrates information that may be included in SCI when an S-PRS is transmitted in a resource pool defined for S-PRS transmission (which may be referred to as a dedicated resource pool for SL positioning) is provided.

When an S-PRS is transmitted in a resource pool where SL communication (data transmission) is performed, control information is transmitted through two-stage SCI including first SCI (see the third embodiment) and second SCI (see the fourth embodiment). However, when an S-PRS is transmitted in a resource pool defined for S-PRS transmission, only one SCI (e.g., first SCI or second SCI) may be defined and transmitted. This format may be referred to as SCI format 1-B. For example, an example of control information that may be included in the one SCI is illustrated below in Table 9. As illustrated in Table 9, some control information may not be included. Further, in the disclosure, the control information is not limited to the control information included in Table 9. Table 9 may include the following changes in the control information included in existing SCI format 1-A.
Frequency resource assignment information, not indicated: When an S-PRS is transmitted in a resource pool defined for S-PRS transmission, a frequency location where the S-PRS is transmitted may be determined by the frequency location of the S-PRS configured by a higher layer, which may be interpreted as the S-PRS being transmitted in the entire area of the configured frequency location. Therefore, an additional UE operation for allocating a frequency resource may not be defined.
PSSCH DMRS-related information (DMRS pattern, number of DMRS ports), not indicated: When an S-PRS is transmitted in a resource pool defined for S-PRS transmission, a PSSCH is assumed not to be transmitted.
Second SCI related information (second stage SCI format, Betta offset indicator), not indicated: When an S-PRS is transmitted in a resource pool defined for S-PRS transmission, only one SCI may be defined and transmitted via a PSCCH.
PSSCH modulation and coding scheme (PSSCHMCS) information, not indicated: When an S-PRS is transmitted in a resource pool defined for S-PRS transmission, a PSSCH is assumed not to be transmitted.
Physical SL feedback channel (PSFCH)-related information, not indicated: When an S-PRS is transmitted in a resource pool defined for S-PRS transmission, a PSFCH for the S-PRS is assumed not to be supported.
S-PRS specific information, included: Related information may include an S-PRS request, an S-PRS measurement report request, an S-PRS comb pattern, an S-PRS comb offset, an S-PRS TDM offset, and/or an SL-PRS symbol number in Table 9.

The control information may include at least some of information or fields included in Table 9. For example, the control information may include only some or all of the information or fields included in Table 9.

TABLE 9

| Field | Bits | Comments |
|---|---|---|
| Priority | 3 | |
| Time resource | 5 [if N_{MAX} = 2 and | |
| assignment | 9 if N_{MAX} = 3] | |
| Resource | ┌log₂ Nᵣₛᵥ_period┐ | |
| reservation period | | |
| Source ID | 8 | |
| Destination ID | 16 | |
| Cast type indicator | 2 | |
| S-PRS request | 1 | New |
| S-PRS | 1 | This information can be removed. |
| measurement report | | |
| request | | |
| S-PRS comb pattern | ┌log₂ P┐ | New |
| | | P is the number of comb patterns |
| | | configured by higher layer parameter sl- |
| | | PRS-CombPatternList. |
| | | One comb pattern can be decided by higher |
| | | layer and this information can be removed. |
| S-PRS comb offset | ┌log₂ N┐ | New |
| | | N is the S-PRS comb size. |
| | | Higher layer can provide this information |
| | | and this information can be removed. |
| S-PRS TDM offset | ┌log₂ T┐ | New |
| | | T is the number of TDMed S-PRS |
| | | resources configured by higher layer |
| | | parameter. |
| | | Higher layer can provide this information |
| | | and this information can be removed. |
| S-PRS symbol | ┌log₂ S┐ | New |
| number | | S is the number of SL-PRS symbols |
| | | configured by higher layer parameter sl- |
| | | PRS-symLengthList. |
| | | Higher layer can provide this information |
| | | and this information can be removed. |
| Reserved | | |

In Table 9, an S-PRS TDM offset is a field indicating the location of S-PRS resources when the S-PRS resources are transmitted by TDM, as described with reference to FIGS. 12A to 12C.

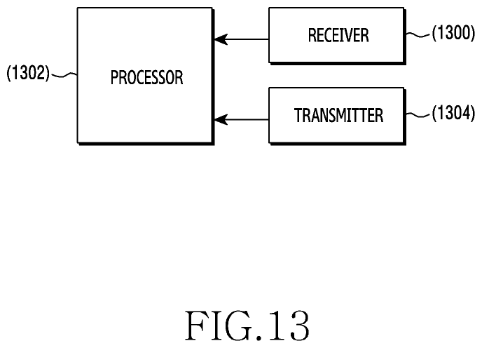

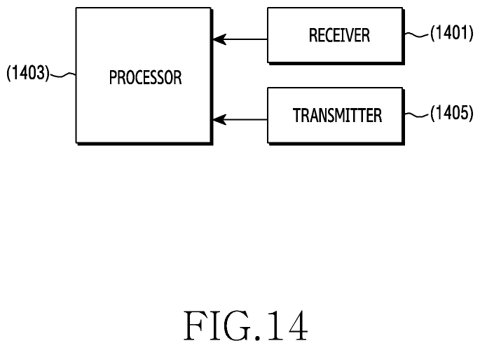

To perform various embodiments of the disclosure, transmitters, receivers, and/or processors of a UE and a base station are illustrated in FIG. 13 and FIG. 14, respectively. For example, the processors may be replaced by at least one processor or controller.

In the foregoing embodiments, a method for a UE to perform positioning in an SL is described. To perform the method, the receiver, the processors, and/or the transmitters of the base station and the UE may each operate based on the embodiments.

FIG. 13 illustrates a UE according to an embodiment.

Referring to FIG. 13, the UE includes a receiver 1300, a transmitter 1304, and a processor 1302. The receiver 1300 and the transmitter 1304 may be collectively referred to as a transceiver. The transceiver may transmit/receive signals with the base station. For example, the signals may include control information and data. To this end, the transceiver may include a radio frequency (RF) transmitter configured to up-convert and amplify the frequency of transmitted signals, and an RF receiver configured to low-noise-amplify received signals and down-convert the frequency thereof. In addition, the transceiver may receive signals through a radio channel, output the same to the processor 1302, and transmit signals output from the processor 1302 through the radio channel. The processor 1302 may control a series of processes such that the UE can operate according to the above-described embodiments of the disclosure.

The first embodiment, the second embodiment, the third embodiment, the fourth embodiment, and the fifth embodiment can be combined with each other as long as they do not contradict each other.

FIG. 14 illustrates a base station according to an embodiment.

Referring to FIG. 14, the base station includes a receiver 1401, a transmitter 1405, and a processor 1403. The receiver 1401 and the transmitter 1405 may be collectively referred to as a transceiver. The transceiver may transmit/receive signals with the UE. For example, the signals may include control information and data. To this end, the transceiver may include an RF transmitter configured to up-convert and amplify the frequency of transmitted signals, and an RF receiver configured to low-noise-amplify received signals and down-convert the frequency thereof. In addition, the transceiver may receive signals through a radio channel, output the same to the processor 1403, and transmit signals output from the processor 1403 through the radio channel. The processor 1403 may control a series of processes such that the base station can operate according to the above-described embodiments of the disclosure.

A method performed by a first UE in a wireless communication system is provided. The method includes receiving, from a second UE, first SCI on a PSCCH, the first SCI including an SCI format field for a second SCI, in case that the SCI format field includes a first value corresponding to an SCI format for an SL PRS for a shared SL PRS resource pool, receiving, from the second UE, the second SCI corresponding to the SCI format on a PSSCH and receiving, from the second UE, the SL PRS on the PSSCH based on the second SCI.

The method further includes receiving, from a base station, configuration information for a SL PRS resource in the shared SL PRS resource pool, wherein the configuration information includes at least one of information on a SL PRS resource ID, information on a number of symbols for the SL PRS resource, information on a starting symbol for the SL PRS resource, or information on a comb offset and a comb size for the SL PRS resource.

SL PRS resource IDs configured based on the configuration information are associated with a slot in the shared SL PRS resource pool.

The second SCI includes an SL PRS request field, and the second SCI further includes a cast type indicator field and a channel state information (CSI) request field of an SCI format 2-A.

The second SCI includes an SL PRS request field, and the second SCI further includes a zone identity (ID) field and a communication range requirement field of an SCI format 2-B.

A first (UE in a wireless communication system is provided. The first UE includes a transceiver; and a controller coupled with the transceiver and configured to receive, from a second UE, first SCI on a PSCCH, the first SCI including an SCI format field for a second SCI, in case that the SCI format field includes a first value corresponding to an SCI format for an SL PRS for a shared SL PRS resource pool, receive, from the second UE, the second SCI corresponding to the SCI format on a PSSCH, and receive, from the second UE, the SL PRS on the PSSCH based on the second SCI.

The controller is further configured to receive, from a base station, configuration information for an SL PRS resource in the shared SL PRS resource pool, and wherein the configuration information includes at least one of information on a SL PRS resource ID, information on a number of symbols for the SL PRS resource, information on a starting symbol for the SL PRS resource, or information on a comb offset and a comb size for the SL PRS resource.

SL PRS resource IDs configured based on the configuration information are associated with a slot in the shared SL PRS resource pool.

The second SCI includes an SL PRS request field, and wherein the second SCI further includes a cast type indicator field and a CSI request field of an SCI format 2-A.

The second SCI includes an SL PRS request field, and wherein the second SCI further includes a zone ID field and a communication range requirement field of an SCI format 2-B.

A method performed by a second UE in a wireless communication system is provided. The method includes transmitting, to a first UE, first SCI on a PSCCH, the first SCI including an SCI format field for a second SCI, in case that the SCI format field includes a first value corresponding to an SCI format for an SL PRS for a shared SL PRS resource pool, transmitting, to the first UE, the second SCI corresponding to the SCI format on a PSSCH and transmitting, to the first UE, the SL PRS on the PSSCH based on the second SCI.

The method further includes receiving, from a base station, configuration information for an SL PRS resource in the shared SL PRS resource pool, wherein the configuration information includes at least one of information on a SL PRS resource ID, information on a number of symbols for the SL PRS resource, information on a starting symbol for the SL PRS resource, or information on a comb offset and a comb size for the SL PRS resource.

SL PRS resource IDs configured based on the configuration information are associated with a slot in the shared SL PRS resource pool.

The second SCI includes an SL PRS request field, and wherein the second SCI further includes a cast type indicator field and a CSI request field of an SCI format 2-A.

The second SCI includes an SL PRS request field, and wherein the second SCI further includes a zone ID field and a communication range requirement field of an SCI format 2-B.

A second UE in a wireless communication system is provided. The second UE includes a transceiver and a controller coupled with the transceiver and configured to transmit, to a first UE, first SCI on a PSCCH, the first SCI including an SCI format field for a second SCI, in case that the SCI format field includes a first value corresponding to an SCI format for an SL PRS for a shared SL PRS resource pool, transmit, to the first UE, the second SCI corresponding to the SCI format on a PSSCH, and transmit, to the first UE, the SL PRS on the PSSCH based on the second SCI.

The controller is further configured to receive, from a base station, configuration information for a SL PRS resource in the shared SL PRS resource pool, and wherein the configuration information includes at least one of information on an SL PRS resource ID, information on a number of symbols for the SL PRS resource, information on a starting symbol for the SL PRS resource, or information on a comb offset and a comb size for the SL PRS resource.

SL PRS resource IDs configured based on the configuration information are associated with a slot in the shared SL PRS resource pool.

The second SCI includes an SL PRS request field, and wherein the second SCI further includes a cast type indicator field and a CSI request field of an SCI format 2-A.

The second SCI includes an SL PRS request field, and wherein the second SCI further includes a zone ID field and a communication range requirement field of an SCI format 2-B.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. As an example, all embodiment of the disclosure may be partially combined with each other to operate a base station and a terminal.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), storage area network (SAN), or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

What is claimed is:

1. A method performed by a first user equipment (UE) in a wireless communication system, the method comprising:
receiving, from a second UE, first sidelink (SL) control information (SCI) on a physical SL control channel (PSCCH), the first SCI including an SCI format field for a second SCI;
in case that the SCI format field includes a first value corresponding to an SCI format for an SL positioning reference signal (PRS) for a shared SL PRS resource pool, receiving, from the second UE, the second SCI corresponding to the SCI format on a physical SL shared channel (PSSCH); and
receiving, from the second UE, the SL PRS on the PSSCH based on the second SCI.

2. The method of claim 1, further comprising:
receiving, from a base station, configuration information for an SL PRS resource in the shared SL PRS resource pool,
wherein the configuration information includes at least one of information on a SL PRS resource identity (ID), information on a number of symbols for the SL PRS resource, information on a starting symbol for the SL PRS resource, or information on a comb offset and a comb size for the SL PRS resource.

3. The method of claim 2, wherein SL PRS resource IDs configured based on the configuration information are associated with a slot in the shared SL PRS resource pool.

4. The method of claim 1, wherein the second SCI includes an SL PRS request field, and
wherein the second SCI further includes a cast type indicator field and a channel state information (CSI) request field of an SCI format 2-A.

5. The method of claim 1, wherein the second SCI includes an SL PRS request field, and
wherein the second SCI further includes a zone identity (ID) field and a communication range requirement field of an SCI format 2-B.

6. A first user equipment (UE) in a wireless communication system, the first UE comprising:
a transceiver; and
a controller coupled with the transceiver and configured to:
receive, from a second UE, first sidelink (SL) control information (SCI) on a physical SL control channel (PSCCH), the first SCI including an SCI format field for a second SCI,
in case that the SCI format field includes a first value corresponding to an SCI format for an SL positioning reference signal (PRS) for a shared SL PRS resource pool, receive, from the second UE, the second SCI corresponding to the SCI format on a physical SL shared channel (PSSCH), and
receive, from the second UE, the SL PRS on the PSSCH based on the second SCI.

7. The first UE of claim 6, wherein the controller is further configured to:
receive, from a base station, configuration information for an SL PRS resource in the shared SL PRS resource pool, and
wherein the configuration information includes at least one of information on an SL PRS resource identity (ID), information on a number of symbols for the SL PRS resource, information on a starting symbol for the SL PRS resource, or information on a comb offset and a comb size for the SL PRS resource.

8. The first UE of claim 7, wherein SL PRS resource IDs configured based on the configuration information are associated with a slot in the shared SL PRS resource pool.

9. The first UE of claim 6, wherein the second SCI includes an SL PRS request field, and
wherein the second SCI further includes a cast type indicator field and a channel state information (CSI) request field of an SCI format 2-A.

10. The first UE of claim 6, wherein the second SCI includes an SL PRS request field, and
wherein the second SCI further includes a zone identity (ID) field and a communication range requirement field of an SCI format 2-B.

11. A method performed by a second user equipment (UE) in a wireless communication system, the method comprising:
transmitting, to a first UE, first sidelink (SL) control information (SCI) on a physical SL control channel (PSCCH), the first SCI including an SCI format field for a second SCI;
in case that the SCI format field includes a first value corresponding to an SCI format for an SL positioning reference signal (PRS) for a shared SL PRS resource pool, transmitting, to the first UE, the second SCI corresponding to the SCI format on a physical SL shared channel (PSSCH); and
transmitting, to the first UE, the SL PRS on the PSSCH based on the second SCI.

12. The method of claim 11, further comprising:
receiving, from a base station, configuration information for an SL PRS resource in the shared SL PRS resource pool,
wherein the configuration information includes at least one of information on an SL PRS resource identity (ID), information on a number of symbols for the SL PRS resource, information on a starting symbol for the SL PRS resource, or information on a comb offset and a comb size for the SL PRS resource.

13. The method of claim 12, wherein SL PRS resource IDs configured based on the configuration information are associated with a slot in the shared SL PRS resource pool.

14. The method of claim 11, wherein the second SCI includes an SL PRS request field, and
wherein the second SCI further includes a cast type indicator field and a channel state information (CSI) request field of an SCI format 2-A.

15. The method of claim 11, wherein the second SCI includes an SL PRS request field, and
wherein the second SCI further includes a zone identity (ID) field and a communication range requirement field of an SCI format 2-B.

16. A second user equipment (UE) in a wireless communication system, the second UE comprising:
a transceiver; and
a controller coupled with the transceiver and configured to:
transmit, to a first UE, first sidelink (SL) control information (SCI) on a physical SL control channel (PSCCH), the first SCI including an SCI format field for a second SCI,
in case that the SCI format field includes a first value corresponding to an SCI format for an SL positioning reference signal (PRS) for a shared SL PRS resource pool, transmit, to the first UE, the second SCI corresponding to the SCI format on a physical SL shared channel (PSSCH), and
transmit, to the first UE, the SL PRS on the PSSCH based on the second SCI.

17. The second UE of claim 16, wherein the controller is further configured to:
receive, from a base station, configuration information for an SL PRS resource in the shared SL PRS resource pool, and
wherein the configuration information includes at least one of information on an SL PRS resource identity (ID), information on a number of symbols for the SL PRS resource, information on a starting symbol for the SL PRS resource, or information on a comb offset and a comb size for the SL PRS resource.

18. The second UE of claim 17, wherein SL PRS resource IDs configured based on the configuration information are associated with a slot in the shared SL PRS resource pool.

19. The second UE of claim 16, wherein the second SCI includes an SL PRS request field, and
wherein the second SCI further includes a cast type indicator field and a channel state information (CSI) request field of an SCI format 2-A.

20. The second UE of claim 16, wherein the second SCI includes an SL PRS request field, and
wherein the second SCI further includes a zone identity (ID) field and a communication range requirement field of an SCI format 2-B.
